(19) United States
(12) Patent Application Publication
(10) Pub. No.: US 2021/0348019 A1
(43) Pub. Date: Nov. 11, 2021

(54) COMPOSITE MATERIALS, USES, AND METHODS

(71) Applicants: Janak HANDA, Toronto (CA); Aiping YU, Waterloo (CA)

(72) Inventor: Aiping YU, Waterloo (CA)

(21) Appl. No.: 17/268,434

(22) PCT Filed: Aug. 13, 2019
(86) PCT No.: PCT/CA2019/051108

§ 371 Date: Feb. 12, 2021

Related U.S. Application Data
(60) Provisional application No. 62/718,224, filed on Aug. 13, 2018.

(51) Int. Cl. C09D 175/04; C09D 7/62; C08K 3/04; F16L 57/06

(52) U.S. Cl. CPC C09D 175/04; C09D 7/62; B82Y 30/00; C08K 3/042; F16L 57/06; C08K 3/041

(57) ABSTRACT

A coating material is provided. The coating material includes a thermoset polymer having at least one functionalized carbon-based filler. The carbon-based filler can be at least one of a carbon nanotube filler, a graphene nano-platelet filler, and a graphene oxide filler. The coating material can be used to coat the surface of elements, such as the inner surfaces of fluid transportation conduits, to protect the elements from erosion, abrasion, and corrosion. This solution can be particularly useful for the transportation of slurries and, more particularly, oil sands.

### CROSS-REFERENCE TO RELATED APPLICATIONS

This application claims the benefit of U.S. Provisional Patent Application No. 62/718,224, filed Aug. 13, 2018, the contents of which are incorporated herein by reference in their entirety.

### FIELD

The specification relates generally to coatings, and, in particular, to composite materials with carbon-based fillers.

### BACKGROUND OF THE DISCLOSURE

Fluid conduits in some applications can be subject to wear and damage from a fluid being transported. For example, where the fluid contains abrasive particles, the interior surface of the conduit can be subjected to erosion, abrasion, and corrosion. This is particularly an issue with oil sand conduits. Where the conduit extends over a significant distance and/or is difficult to access (because, for example, it is subterranean), replacing the segment of the conduit that is excessively worn or damaged can be costly in terms of time, resources, and materials.

In order to prevent or reduce the wear and damage caused by the fluid being channeled, manufacturers have focused on the use of a polyurethane liner in the conduit to prevent erosion and corrosion. The erosion and corrosion resistances can be at least partially related to the migration of the gas, salt ion and other chemicals in the pipe during the operation. In some cases, the polyurethane layer is combined with a layer of rubber, such as disclosed in U.S. Patent Application Publication No. 2014/0116518 to Irathane Systems, Inc. and U.S. Pat. No. 8,397,766 to Rosen but these liners can be costly.

### SUMMARY OF THE DISCLOSURE

In an aspect, there is provided a coating material, comprising a thermoset polymer having a functionalized carbon-based filler.

In another aspect, there is provided a coating set on a surface of an element, comprising a thermoset polymer having a functionalized carbon-based filler.

In the coating material and the coating set on the surface of the element, the carbon-based filler can include carbon nanotubes. The carbon nanotubes can be functionalized using at least one of at least one hydroxyl functional group and at least one carboxyl functional group.

The carbon-based filler can include at least one of graphene nanoplatelets and graphene oxide. The carbon-based filler can be functionalized via at least one of a hydrocarbon group, a longer chain hydrocarbon, a multi-branch amine, and surface modification with a polymer compatible with the thermoset polymer.

The coating material can be formed by polymerizing an isocyanate-based monomer, an oligomer containing a hydroxyl group, and the carbon-based filler.

The carbon-based filler can be a graphene oxide that was chemically modified with a naphthyl amine group, such as an N-phenyl-2-naphthyl amine group.

In a further aspect, there is provided a fluid transportation conduit system, comprising: a fluid transportation conduit having an inner surface defining a channel; and a thermoset polymer having a functionalized carbon-based filler set on the inner surface of the fluid transportation conduit.

The carbon-based filler can include carbon nanotubes. The carbon nanotubes are functionalized using at least one of at least one hydroxyl functional group and at least one carboxyl functional group.

The carbon-based filler can include at least one of graphene nanoplatelets and graphene oxide. The carbon-based filler can be functionalized via at least one of a hydrocarbon group, a longer chain hydrocarbon, a multi-branch amine, and surface modification with a polymer compatible with the thermoset polymer.

The coating material is formed by polymerizing an isocyanate-based monomer, an oligomer containing a hydroxyl group, and the carbon-based filler.

The carbon-based filler can be a graphene oxide that was chemically modified with a naphthyl amine group, such as an N-phenyl-2-naphthyl amine group.

The fluid transportation conduit can be a slurry transportation conduit. The slurry transportation conduit can be an oil sand transportation conduit.

In yet another aspect, there is provided a method of manufacturing a coating material, comprising mixing a thermoset polymer with a functionalized carbon-based filler.

The carbon-based filler can include carbon nanotubes. The carbon nanotubes can be functionalized using at least one of at least one hydroxyl functional group and at least one carboxyl functional group.

The carbon-based filler can include at least one of graphene nanoplatelets and graphene oxide. The carbon-based filler can be functionalized via at least one of a hydrocarbon group, a longer chain hydrocarbon, a multi-branch amine, and surface modification with a polymer compatible with the thermoset polymer.

The mixing can comprise polymerizing an isocyanate-based monomer, an oligomer containing a hydroxyl group, and the carbon-based filler.

The carbon-based filler can be a graphene oxide that was chemically modified with a naphthyl amine group, such as an N-phenyl-2-naphthyl amine group.

In still yet another aspect, there is provided a method of manufacturing a fluid transportation conduit system, comprising applying a coating to an inner surface of a fluid transportation conduit, the inner surface defining a channel, the coating being a composite of at least a thermoset polymer and functionalized carbon-based filler.

The carbon-based filler can include carbon nanotubes. The carbon nanotubes can be functionalized using at least one of at least one hydroxyl functional group and at least one carboxyl functional group.

The carbon-based filler can include at least one of graphene nanoplatelets and graphene oxide. The carbon-based filler can be functionalized via at least one of a hydrocarbon group, a longer chain hydrocarbon, a multi-branch amine, and surface modification with a polymer compatible with the thermoset polymer.

The coating can be formed by polymerizing an isocyanate-based monomer, an oligomer containing a hydroxyl group, and the carbon-based filler.

The carbon-based filler can be a graphene oxide that was chemically modified with a naphthyl amine group, such as an N-phenyl-2-naphthyl amine group.

The fluid transportation conduit can be an oil sand transportation conduit.

### BRIEF DESCRIPTIONS OF THE DRAWINGS

For a better understanding of the various embodiments described herein and to show more clearly how they may be carried into effect, reference will now be made, by way of example only, to the accompanying drawings in which:

FIG. 1 is a partial sectional view of an oil sands conduit in accordance with an embodiment;

FIG. 2a shows a polyurethane composite film, with a plain polyurethane sample and two polyurethane (“PU”)/carbon nanotube (“CNT”) samples in accordance with embodiments;

FIGS. 2b to 2d represent the ATR-IR spectrum of the samples of FIG. 1 respectively;

FIGS. 3a to 3c show cross-sections of the samples of FIG. 1 respectively;

FIGS. 4a to 4c show the chemical reaction mechanism of PU and the expected chemical interaction mechanism between the two PU/CNT samples;

FIG. 5 is a stress-strain relationship graph for increases in the filler content;

FIGS. 6a and 6b are graphs showing a comparison of the tensile strength and the Young's modulus of the materials;

FIG. 7 are Tafel plots for the above-mentioned samples;

FIG. 8 shows Nyquist plots for copper substrates coated with plain PU, and PU with carbon-based filler;

FIGS. 9a and 9b show equivalent circuits for modelling electromechanical impedance data for plain copper conduit and for copper conduit coated with various coatings as described above;

FIG. 10 is a schematic diagram of a process of fabricating a coating in accordance with another embodiment;

FIG. 11 shows a set of specimen images of PU/graphene nano-platelets (“GnP”) for electrochemical measurement;

FIGS. 12a to 12d show a set of scanning electron microscopes (“SEM”) images for different GnP grades;

FIG. 13 shows an X-ray power diffraction spectrum for four commercial grades of GnPs;

FIGS. 14A and 14B are strain-stress graphs of PU and PU/GnP composites made using the grades of GnPs from FIG. 13 at 1 wt % and 6 wt % GnP loading respectively;

FIGS. 15A and 15B are Halpin-Tsai prediction and experimental curves respectively of the PU/GnP composites for the tensile modulus as a function of volume fraction of GnP;

FIG. 16 shows Tafel plots for plain copper, copper coated with PU, and copper coated with the PU/GnP composites of FIGS. 14A to 15B;

FIG. 17 shows Nyquist plots for the materials of FIG. 16;

FIGS. 18a and 18b show bode and phase plots respectively for the materials of FIG. 16;

FIGS. 19a to 19h are cross-sectional SEM images for various polyurethane/GnP composites;

FIGS. 20a and 20b are cross-sectional SEM images for the surface of the PU/H100 composite;

FIGS. 21a to 21e are schematic models for the permeation of corrosive agents passing through the coating layer of a PU composite containing 1 wt % GnP;

FIG. 22a shows the chemical structure of graphene oxide (“GO”);

FIGS. 22b and 22c show the chemical structure of a hydroxyl group and an epoxide group respectively;

FIG. 23 shows the process of creating GO;

FIG. 24 shows the process of dispersing GO into polyol and conducting in-situ polymerization;

FIG. 25 is a schematic image of a thinky mixer;

FIG. 26a shows a polyol/tetrahydrofuran (“THF”) mixture and a polyol/[GO/THF] mixture;

FIG. 26b shows the polyol/tetrahydrofuran (“THF”) mixture and the polyol/[GO/THF] mixture after removal of the THF;

FIGS. 27a to 27d show a PU alone, solution mixed with GO, physically mixed with GO, and physically mixed with reduced GO (“RGO”);

FIG. 28 is a strain-stress curve graph for neat PU, and PU/GnP, PU/GO, PU/RGO, and an alternative PU;

FIG. 29 is a Tafel plot of copper piping, either uncoated or coated with one of neat PU, PU/M5, PU/GO, and PU/RGO;

FIGS. 30a to 30c show the chemical structure of surface modifiers used to modify the surface of GO;

FIG. 30d shows a method of chemically modifying the surface of GO with a functional group;

FIGS. 31a to 31d shows the chemical structure of various surface modifying chemicals;

FIG. 32 shows stress graphed versus strain percent for neat PU, PU/GO, PU/GO2NA, and a baseline; and

FIG. 33 is a Tafel plot of copper, neat PU, PU/GO 0.5 wt %, and PU/GO2NA 0.5 wt %.

### DETAILED DESCRIPTION

For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Corrosion, commonly known as rusting, is defined as a chemical or electrochemical reaction between a metal substrate and a corrosive agent such as oxygen or moisture. Corrosion mitigation is desirable in modern industries owing to the high cost of maintenance and replacement of parts. Organic coatings are the most common method for protecting metal surfaces from a corrosive environment.

In the past couple of decades, the use of oil sands as a source for crude oil/bitumen has increased significantly. Oil sands can be defined as the deposit of loose sand or partially consolidated sandstone containing petroleum or other hydrocarbons. Oil sands have introduced some challenges, like the transportation of the oil sands from the sand mines to the initial process station. This stage of transportation is called primary transportation. During this primary transportation, there is an added challenge of erosion of the interior pipeline coating due to the presence of solid rock particles in the transported oil sands slurry. In order to overcome the issue of erosion along with corrosion, improved mechanical properties of the interior pipeline coating are desirable.

Among diverse organic materials, polymer coatings are widely used as a protective layer to prevent corrosion because they provide not only high corrosion resistance but also excellent adhesion to metal substrates. For instance, polyurethane (“PU”) and epoxy are commonly used coating materials as the protective layer on metal substrates to overcome the challenge of erosion along with corrosion in oil sands transportation. PU has attracted many researchers because of its exceptional flexibility, high tensile strength, better abrasion properties compared to other polymers, higher tear strength to overcome the erosion problems in the pipeline, as well as excellent adhesion to the metal. PU is based on the reaction between the isocyanate (—NCO) group and a polyol including hydroxyl groups (—OH), where the isocyanate group and polyol comprise a hard segment and soft segment respectively. Due to the segmented structure, PU has high strength and elongation. For this reason, PU has been applied to various fields and industries such as construction, oil and gas industry, automotive, and health care owing to its broad versatility. However, PU has inferior abrasion resistance and gas permeability relative to a metal, both of which are necessary for use in harsh conditions such as oil sands transportation. In addition to good mechanical characteristics, PU-based materials also carry good corrosion resistive performance due to their chemical stability which is another valuable characteristic for interior pipeline coating to transport oil sands.

PU generally consists of a high molecular weight soft segment which is the polyester or polyether macrodiol and a low molecular which is the diol or diamine and a hard segment which is the di-isocyanate. The microphase separation of the hard and the soft segments due to the thermodynamic incompatibility is a factor in determining the structure of the PU matrix. The modification of PU mainly focuses on improving the mechanical properties and corrosion properties. In general, there are two approaches: the first is to change the molecular structure of PU by modification of its three basic building blocks: polyol, diisocyanate, and the chain extender. Polyol type plays a role for PU properties. The second is to introduce the filler into the polyurethane matrix. The disadvantages are that adding these fillers often worsens the fatigue behavior and reduces the elongation at break.

To overcome this problem, numerous researchers have fabricated a polymer composite incorporating various carbon-based nano-fillers, such as a layered silicate, carbon nanotubes (“CNTs”), graphene, and graphene nano-platelets (“GnPs”) to improve such properties. Among them, nanocomposites integrated with graphene and GnPs are recently emerging as a new breakthrough.

CNTs, because of their high aspect ratio, high mechanical strength, electrical and thermal conductivity, and thermal stability, are used as reinforcing fillers in composite materials. These materials can keep the polymer matrix properties (elasticity, strength, and modulus) with the additional enhancement of exceptionally high electrical and thermal conductivity. Novel CNT-polymer composites open opportunities for new multi-functional materials with broad commercial and defense applications. The big challenges encountered in making such a composite are the uniform dispersion of CNTs in polymer matrix without agglomerates and entanglements, and the improved nanotubes-resin interface adhesion.

Disclosed herein are different compositions of thermopolymers functionalized via various carbon-based fillers, including CNTs and GnPs that are functionalized via at least one of at least one hydroxyl functional group and at least one carboxyl functional group.

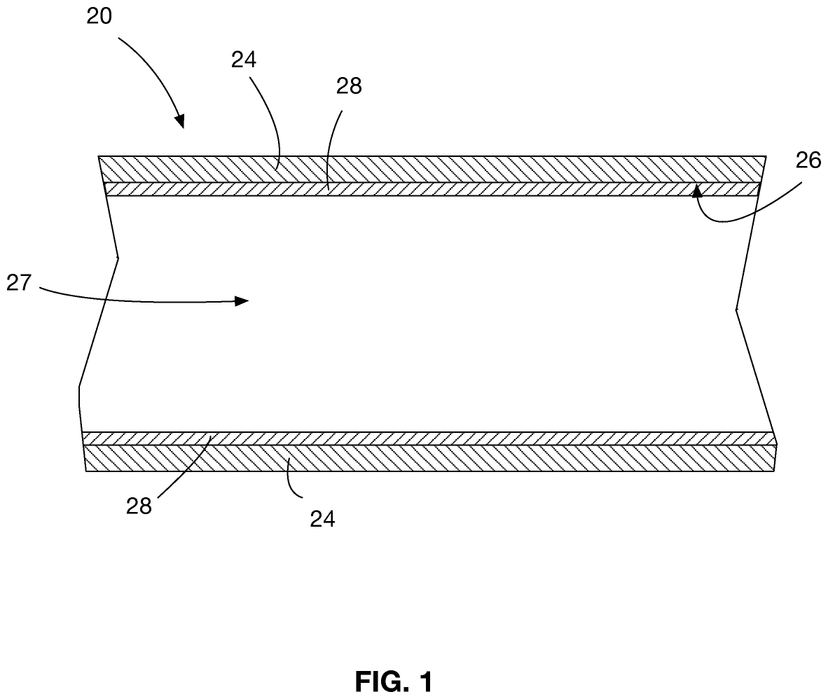

FIG. 1 shows a fluid transportation conduit section 20. In particular, the fluid transportation conduit in this embodiment is an oil sand pipeline. The fluid transportation conduit section 20 is a pipe having a pipe wall 24. An inner surface 26 of the fluid transportation conduit section 20 defines a channel 27 through which a fluid is transported. A coating 28 is applied to the inner surface 26 of the fluid transportation conduit section 20. In this particular embodiment, the fluid is oil sand, but in other embodiments, can be any other type of fluid, such as various other slurries, gases, etc.

The coating 28 is a thermopolymer composite that includes a carbon-based filler. In particular, the thermopolymer is PU, and the carbon-based filler is functionalized CNTs. In other embodiments, other suitable thermopolymers with desirable characterstics can be employed. Further, other carbon-based fillers, such as GnPs and reduced graphene oxide (“GO”), can be used.

### Functionalized CNTs

Different types of functionalized CNT fillers, such as OH-functionalized CNTs and COOH-functionalized CNTs, have been analyzed in terms of what they add to thermopolymer coatings, including their mechanical properties and their corrosion/electrochemical properties. It has been found that the addition of functionalized CNTs to the PU matrix improves the mechanical properties of the PU by up to 27.27% and the protection efficiency of the PU under corrosive environment has increased from 92.56% to 99.11%. This increased performance of the PU-CNT composite can be attributed towards the addition of functionalized CNT fillers in the primary polymer matrix. The difference in the performance of the OH-functionalized and the COOH functionalized CNTs can be a function of the aspect ratios of the CNTs.

TABLE 1
Characteristics of CNT filler

| | Surface Area | Length | Diameter | Functionalized |
|---|---|---|---|---|
| Filler | (m2/g) | (μm) | (nm) | Group weight % |
| CNT-OH | 117 | 10-50 | 8-15 | 2 |
| CNT-COOH | 233 | 10-30 | 10-20 | 1.8 |

The —OH and —COOH functionalized CNTs were used. The as-grown CNTs were produced by CCVD, in which CH₄ or C₂H₂ were converted into CNTs at 700 and 1000 degrees Celsius in the presence of a Ni—La₂O₃ catalyst. The diameter of CNT—OH and CNT—COOH was at 8-15 nanometers, and 10-20 nanometers, respectively.

The preparation of a polyol/CNT dispersion was performed as follows. Typically, 8 g of polyol was mixed with the functionalized CNT filler. This mixture was then subjected to mechanical stirring using a magnetic needle at 750 rpm for 30 minutes. Then the mixture was then subjected to 60 minutes in a planetary centrifugal mixture (“PCM”). The PCM was chosen due to the high viscosity of the polyol. The process leads to a uniform dispersion of the —OH/—COON functionalized CNT in the highly viscous polyol.

Then the PU-CNT composite was prepared. The MDI was added to the PU/CNT mixture in the ratio 2:1 (polyol:MDI). The mixture was then subject to 10 minutes in the PCM and 5 minutes inside a sonicator bath. This ensured uniform mixing of the MDI and the polyol/CNT mixture.

The final PU/CNT mixture was then cast into a thin film on a Teflon/PET surface with controlled thickness. The film was then cured inside a vacuum chamber oven at 50 degrees Celsius for a period of 16 hours.

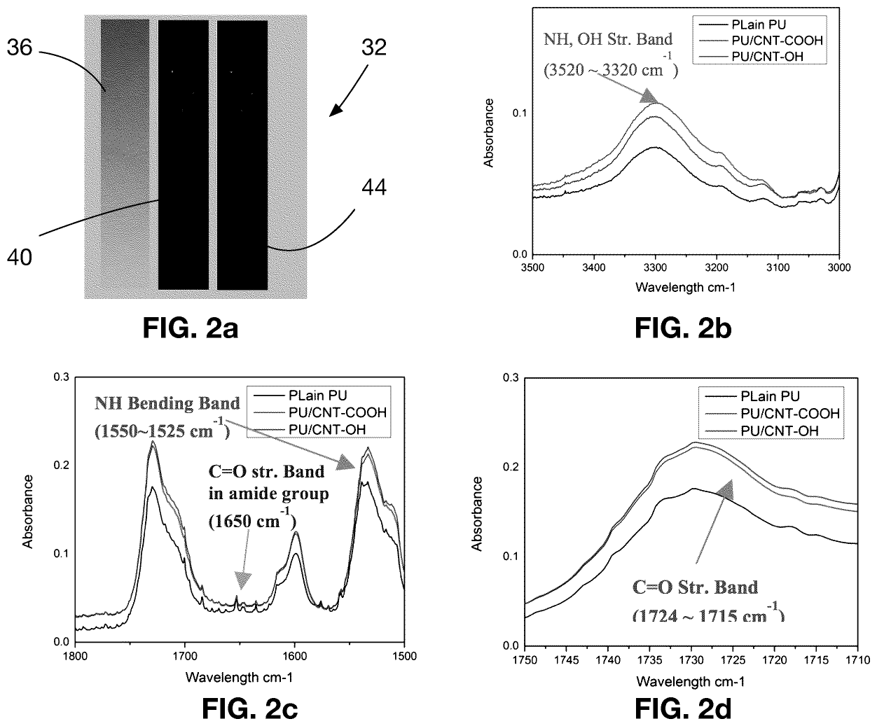

FIG. 2a shows the PU-CNT composite film 32, with a plain PU sample 36, a PU/CNT-OH sample 40, and a PU/CNT-COON sample 44.

The tensile tests were carried out using an ADMET eXpert 7603 equipment at room temperature. The samples were prepared following the ASTM standards for thin film. The specimens were stretched until the point of failure at a strain rate of 100 millimeters/minute. The stress-strain characteristics were recorded and the tensile strength, Young's modulus and the elongation values are an average value from 5 samples.

The Fourier transform infrared spectroscopy (FTIR) spectra of the samples in KBr pellets were recorded on a Burker Tensor 27 FTIR spectrometer using the ATR mode. The spectra were collected from 500 to 4000 cm⁻¹ with a 4 cm⁻¹ resolution.

A VSP-300 workstation from Uniscan Instruments Ltd., was used for electrochemical measurements. The corrosion cell was covered with a Teflon™ plate with holed for the electrode placements. The configuration consisted of two graphite rod counter electrodes (CE), one Ag/AgCl reference electrode (RE) and the working electrode (WE). The specimen was secured in a Teflon sample holder with an exposed surface area of 1 cm² and was stabilized at room temperature in a 3.5% NaCl electrolyte solution prior to testing. All the measurements were repeated five times for accuracy.

A desirable physical property for the PU is the phase separation between the soft segment (diol) and the hard segment (MDI). The degree of phase separation can be estimated by the work disclosed in R. W. Seymour, G. M. Ester and S. L. Cooper, Macromolecules, 1970, 3, 579. The NH group constitutes for the hydrogen bonds by being the proton donor and the oxygen acts as the proton acceptors that is present in the carbonyls of the hard segment and also in the ethers of the soft segment. The formation of the hydrogen bonding by the —C═O can be identified by the peak at ˜1705 cm−1 and for the free —C═O there is a peak at ˜1728 cm−1. The PU reaction with the CNTs results in a hydrogen bond interaction between the CNT and the polyurethane chain.

FIGS. 2b to 2d represent the ATR-IR spectrum of the plain PU, the PU/CNT-OH composite, and the PU/CNT-COON composite respectively. This demonstrates the chemical reaction mechanism explained in the previous section and the formation of the hydrogen bonding between the PU matrix and the CNT fillers.

Scanning electron microscope (“SEM”) images were compared between the polyurethane and the PU/CNT composites. The cured samples were dipped into a liquid nitrogen bath to freeze the samples. The samples were then broken to obtain a clean cross-sectional image from the SEM.

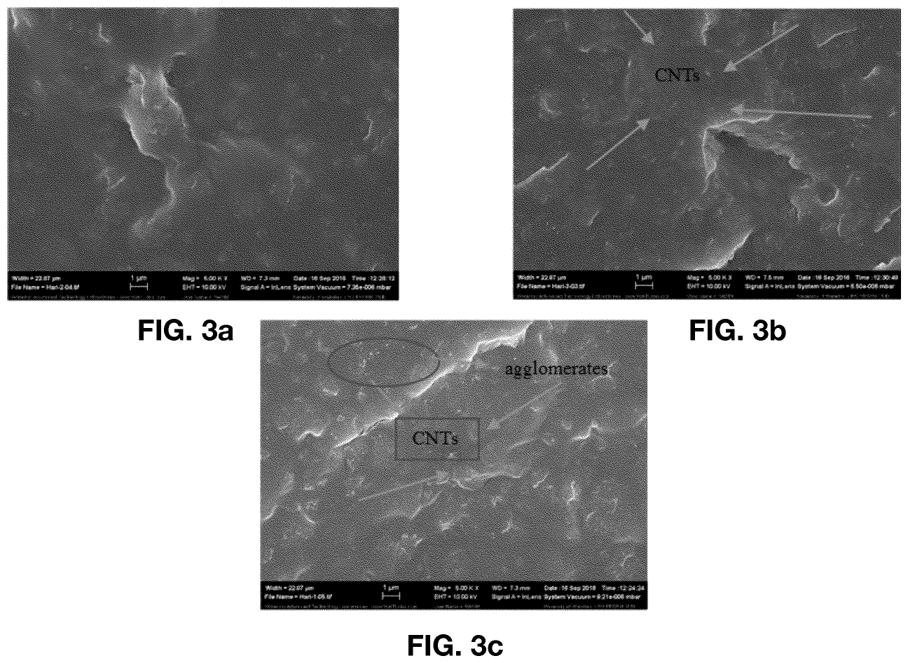

FIGS. 3a to 3c show the cross-sectional images of the plain polyurethane, the polyurethane/CNT-COON composite material, and the polyurethane/CNT-OH composite material respectively. The CNTs were visible in the composite material. The reason for the sporadic appearances of the CNTs were due to the low filler loading. From the SEM images, it can be seen that the —OH functionalized CNTs caused agglomeration due to the higher surface area and the —COON functionalized CNTs were more dispersed along the polymer matrix.

The PUs are made by exothermic reactions between alcohols with two or more reactive hydroxyl (—OH) groups per molecule (diols, triols (or) polyols) and isocyanate with more than one reactive cyanate group (—NCO) per molecule. Urethane linkage is the group formed by the reaction between the two molecules.

The linkage between the polyurethane molecule and the functionalized CNT occurs due to a hydrogen bonding between the CNT and the polyurethane matrix.

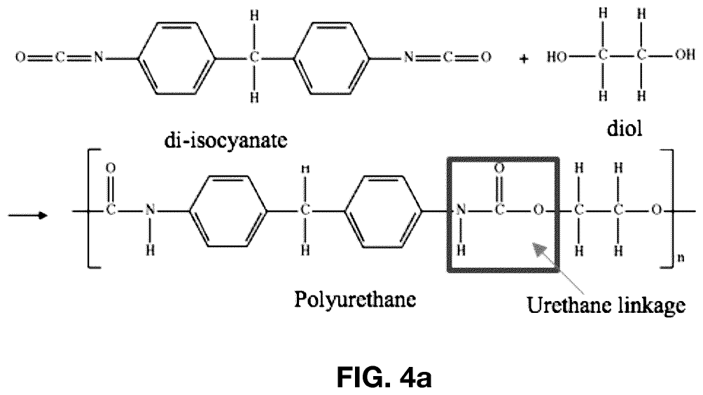

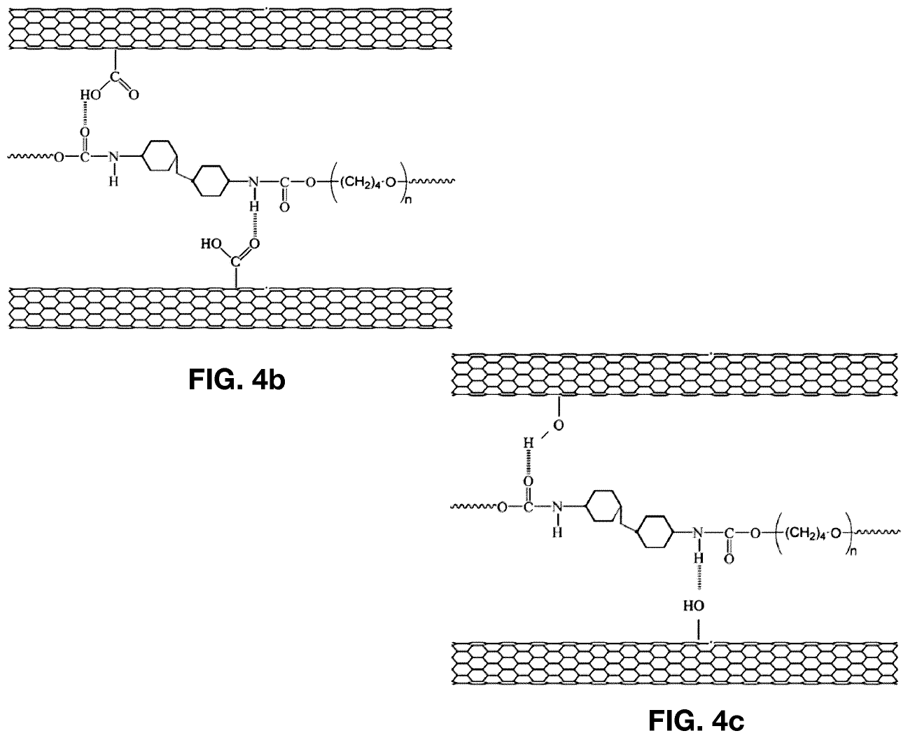

FIG. 4a shows the chemical reaction mechanism of PU. The expected chemical interaction mechanism between CNT-COOH and CNT-OH is shown in the FIGS. 4b and 4c respectively.

A tensile test was conducted using the ADMET eXpert 7603 equipment. The thin film samples were prepared with a thickness of 0.44 mm. The test was conducted with a constant strain rate of 100 millimeters/minute until the failure point/fracture of the samples.

Table 1 above presents the properties of the CNT-OH and CNT-COOH filler materials used, and Table 2 below details the mechanical performance of the PU with the two filler materials. It is clear that the addition of CNT improves the tensile strength of the PU. The addition of CNT-OH improves the tensile strength by 27.27% and the addition of CNT-COOH improves the tensile strength by 5.5%. In addition to the tensile strength, there is a clear decline in the maximum strain percent of the PU with increases in the addition of filler. This can be attributed to the increase in rigidity of the polymer matrix due to the addition of filler material.

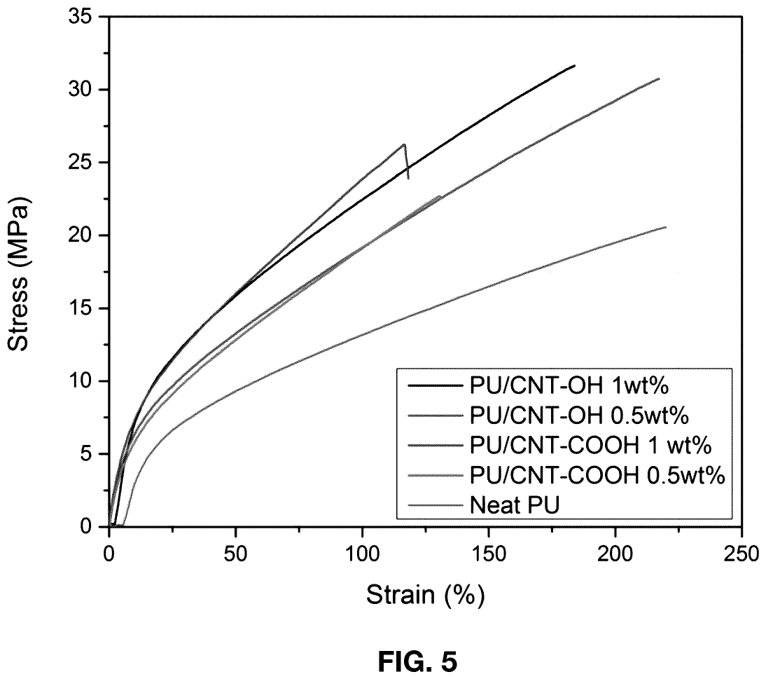

FIG. 5 shows the stress-strain relationship and the change in the stress-strain graph with increase in the filler content. In addition to the improvement in the tensile strength the addition of CNT filler also improves the Young's modulus of the polymer system. From Table 2, it can be seen that there is a maximum of 49.45% increase in the Young's modulus with the addition of CNT-OH filler and 84.48% increase in the Young's modulus with the addition of CNT-COOH fillers. From the ATR-IR results, there is no significant difference in the bonding characteristics of these two fillers with the polymer matrix. The difference in the tensile characteristics of the composite material can be attributed to the difference in the aspect ratio of the CNT filler. The CNT-OH filler has an aspect ratio range of 1.25-6.0 and the CNT-COOH has an aspect ratio range of 1.0-3.0. With a higher aspect ratio, there is a higher increase % in the tensile strength but, due to the higher aspect ratio, the elongation properties of the composite material are negatively affected. It has been generally found that the most suitable characteristics are achieved when the aspect ratio of the carbon-based filler is maintained at 2% or below.

TABLE 2
Tensile Characteristics of polyurethane
and polyurethane composites

| | | Contents | Max | Stress | Young's |
|---|---|---|---|---|---|
| PU | Filler | (wt %) | Strain % | Mpa | modulus |
| RenCast 6401 | CNT-OH | 0.5 | 235.47 | 30.74 | 13.08 |
| RenCast 6401 | CNT-OH | 1 | 192.06 | 31.64 | 16.47 |
| RenCast 6401 | CNT-COOH | 0.5 | 142.51 | 22.70 | 15.98 |
| RenCast 6401 | CNT-COOH | 1 | 129.23 | 26.23 | 20.33 |
| PU Neat | | | 226.53 | 24.86 | 11.02 |

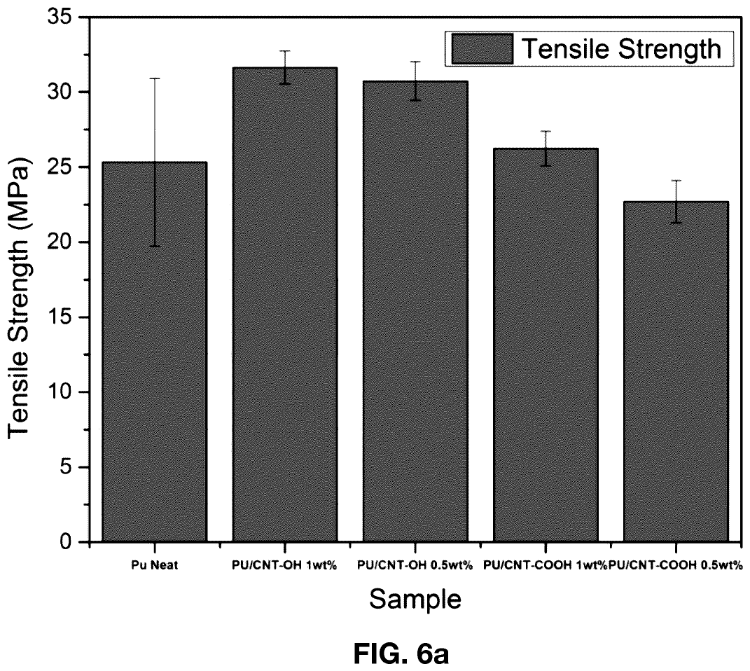

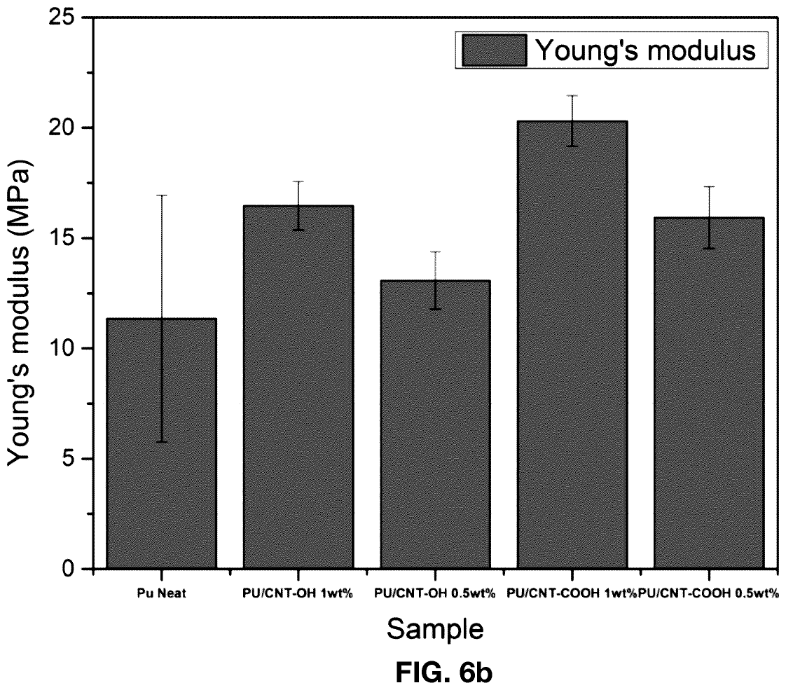

FIGS. 6a and 6b show the comparison of the tensile strength and the Young's modulus of the material.

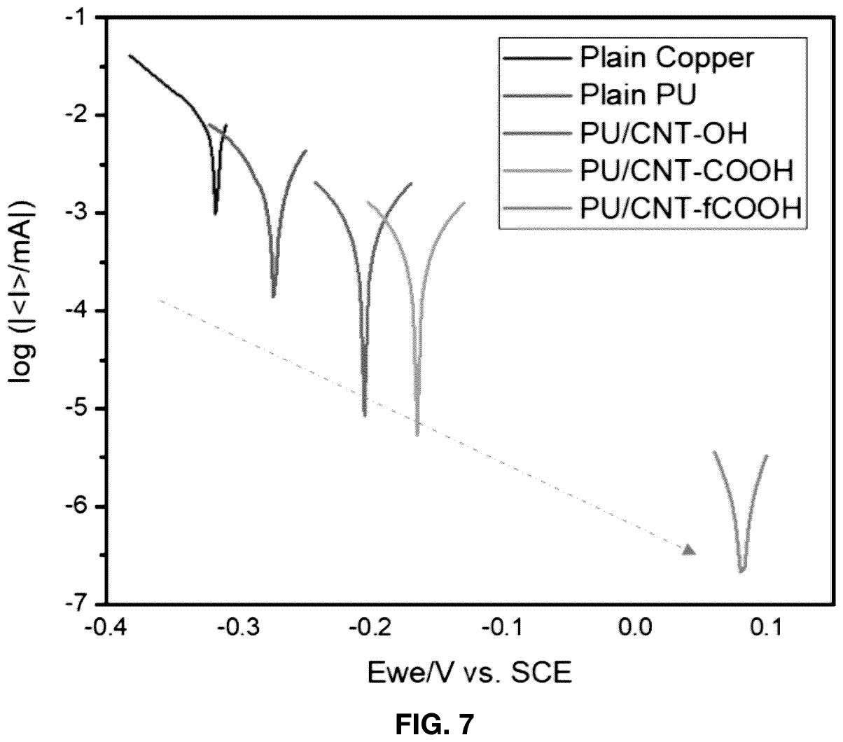

Cyclic voltammeter and impedance spectroscopy were utilized to study the electrochemical behaviors of plain copper substrate, copper substrate coated with PU, copper substrate coated with PU/CNT-OH composite, and copper substrate coated with PU/CNT-COOH composite. All the measurements were conducted in a temperature controlled 3.5% NaCl solution. The cyclic voltammeter technique was carried out to produce Tafel plots for the same above-mentioned samples shown in FIG. 7.

The corrosion potential and the corrosion current values were obtained from the Tafel plots. The variation in the corrosion potential and the corrosion currents are reported in Table 4 below. This shows the difference in the corrosion resistant performance of these coating materials. With the addition of filler material, the CNT-OH has improved the protection efficiency of the coating material by 6.22% and the CNT-COOH has improved the protection efficiency by 6.6%. From the parameters reported in Table 3, it is clear that there is a positive shift in the E_{corr} value after coating the copper substrate. The corrosion performance can also be quantified by the protection efficiency numbers.

$${P}_{E F} = ( 1 - \frac{{I}_{c o r r}}{{I}_{corr}^{0}} ) \times 100 \qquad ( 1 )$$

The corrosion resistance performance has clearly improved by the addition of carbon-based fillers. This can be inferred from the shift in the corrosion potential and the corrosion current and also from the improvement in performance efficiency. The reason for this improvement in performance can be attributed to the surface area of the filler materials as mentioned in Table 1. With the increase in the surface area of the filler, the corrosion resistance performance has improved. This is due to the fact that with the increase in the surface area there are fewer agglomerates (better dispersion) formed in the polymer matrix, and hence the protection efficiency is higher. This result is consistent with the inference from the impedance spectroscopy as shown in Table 3.

TABLE 3
Electrochemical corrosion parameters obtained
from cyclic voltammeter tests

| | | | | Protection | |
|---|---|---|---|---|---|
| | Ecorr | Icorr | Filler | Effi- | Thickness |
| Sample | (mV) | (uA) | wt % | ciency % | mm |
| Copper plain | −205.145 | 16.785 | — | — | — |
| PU Plain | −179.353 | 1.248 | — | 92.56% | 0.45 |
| PU/CNT-OH | −171.514 | 0.281 | 1 wt % | 98.32% | 0.44 |
| PU/CNT-COOH | −166.220 | 0.149 | 1 wt % | 99.11% | 0.44 |

Electrochemical impedance spectroscopy (“EIS”) is a widely used technique for studying the activity on metal substrates. This technique was used here to study the variation in corrosion activities between bare and coated copper substrates. In EIS, alternating current is fed to the corrosion system over a wide range of frequencies and the impedance of the working electrode is reported as a complex value. The impedance behaviour of the working electrode can be modelled using an equivalent circuit.

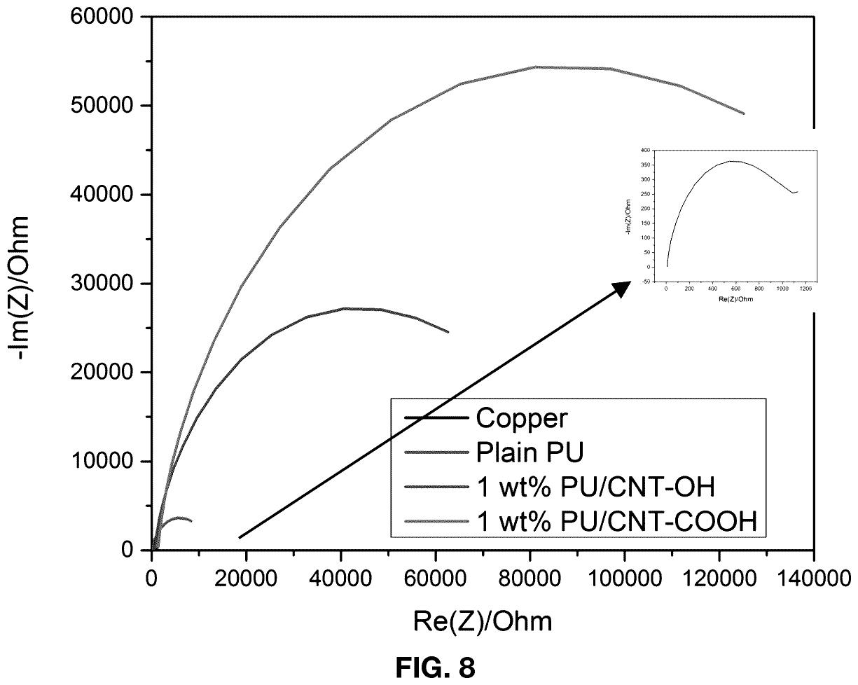

FIG. 8 depicts Nyquist plots for copper substrate coated with plain PU, PU/CNT-OH and PU/CNT-COOH composites, which represent the real and the imaginary parts of the impedance data. Here, a typical impedance response of copper in a NaCl solution is observed, where the impedance is characterized by a semicircle followed by a sharp increase in impedance. In general, a larger semicircle represents a larger resistance and consequently a slower corrosion rate. The ability of polyurethane to mitigate corrosion is clearly evident by the much larger semicircle for the PU-coated substrate compared to the bare copper substrate. The size of the semi-circle goes larger with the addition of filler material.

The corrosion resistance of —COON functionalized filler appears to be better than that of the —OH functionalized filler material. The results are inconsistent with the results from the cyclic voltammeter tests, the CNT-OH filler increases the protection efficiency of the coating by 5.05% and the CNT-COOH filler increases the protection efficiency of the coating by 5.95%. This discrepancy in the protection efficiency is because of the approximation that is used in calculation of the protection efficiency from the EIS measurements. This increase in the protection efficiency of the different fillers is attributable to the surface area of the carbon-based fillers. With an increase in the surface area of the filler material, the protection efficiency of the composite material increases.

In addition to the qualitative investigation, an equivalent circuit was used to fabricate the electrochemical impedance behaviour of the coatings and the substrates.

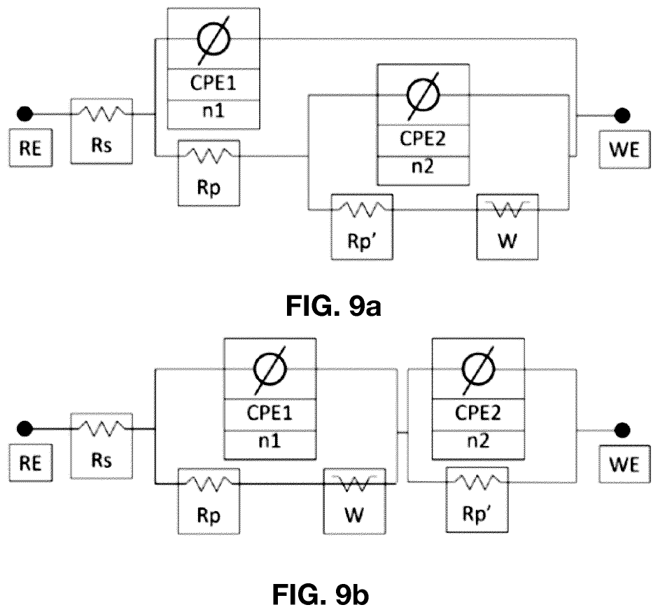

FIGS. 9a and 9b show equivalent circuits for modelling electromechanical impedance data for plain copper, and coated copper substrate with plain PU, PU/CNT-OH and PU/CNT-COOH composites respectively that were used for this purpose. The unique combination of the various elements in the circuit is a well-known representation of impedance data for copper substrates. The values of the various parameters in the equivalent circuit are tabulated in Table 4.

TABLE 4
Electrochemical Corrosion parameters obtained from equivalent circuit

| | Rₛ | Rₚ | CPE₁ | R′ₚ | CPE₂ | W | P_{EF} |
|---|---|---|---|---|---|---|---|
| Sample | (Ω cm²) | (Ω cm²) | (Ω⁻¹ Sⁿ¹ cm⁻²) | (Ω cm²) | (Ω⁻¹ Sⁿ² cm⁻²) | (Ω⁻¹ Sⁿ¹ cm⁻ [symbol] | % |
| Copper | 5.5 | 8.3 × 10² | 2.4 × 10⁻⁵ | 1.4 × 10³ | 1.2 × 10⁻³ | 1.4 × 10⁻³ | — |
| Plain PU | 4.8 | 5.0 × 10⁴ | 1.0 × 10⁻⁶ | 9 × 10⁴ | 3.1 × 10⁻¹² | 4.8 × 10³ | 94 |
| PU/CNT-OH | 5.6 | 2.0 × 10⁴ | 1.4 × 10⁻¹⁰ | 6.4 × 10⁵ | 3.9 × 10⁻⁹ | 1.0 × 10⁴ | 98.78 |
| PU/CNT-COOH | 5.9 | 1.8 × 10⁴ | 1.6 × 10⁻⁸ | 2 × 10⁶ | 1.1 × 10⁻¹⁰ | 2.7 × 10⁴ | 99.6 |

[symbol]

indicates data missing or illegible when filed

The results in Table 4 confirm the advanced corrosion inhibition performance of PU/CNT-COOH over other coatings. The charge transfer resistance R′ₚ, of PU/CNT-OH coating is 84% higher than the plain PU and for the PU/CNT-COOH coating the charge transfer resistance of R′ₚ is 95.5% higher than the plain PU coating. Furthermore, the enhancement in corrosion protection is illustrated by the presented protection efficiencies of the protective coatings, which agree with values in Table 3.

The dispersion of the functionalized CNT in the polyol was realized by mechanical stirring and the use of planetary centrifugal mixer. The MDI was then added to the polyol/CNT mixture and cured to prepare polyurethane/CNT composite. The tensile test results suggested that the addition of functionalized CNT improved the tensile strength and the Young's modulus of the PU. The performance of the OH-functionalized CNT was better in the tensile strength compared to the COOH-functionalized CNT. The COOH-functionalized CNT performance resulted in a higher Young's modulus compared to the OH-functionalized CNT. This difference in the performance of the carbon-based fillers can be attributed to the difference in the aspect ratio of the CNT-OH and CNT-COOH fillers. With an increase in the aspect ratio, the tensile strength of the composite material increase and vice versa for the Young's modulus due to the increased stiffness of the composite with higher aspect ratio filler material. Electrochemical performance of the polyurethane composite on a copper base was testing using cyclic voltammeter. This test resulted in the fact that the plain polyurethane on the copper substrate improved the corrosion resistance of the material. In addition to that, the addition of carbon-based fillers (CNTs) resulted in a higher corrosion resistance R_{corr} value compared to the plain polyurethane. The CNT-OH filler improved the protection efficiency of the composite material by 6.2% and the CNT-COOH filler improved the protection efficiency by 6.6%. This change in the protection efficiency due to the different filler material can be attributed towards the surface area of the filler material, the higher the surface area, the higher the protection efficiency.

### Graphene

Graphene is a two-dimensional plate structure that consists of sp²-bonded carbon atoms. It has outstanding mechanical (elastic modulus: 1 TPa), thermal (thermal conductivity: 5000 W/(m·K)) and electrical (electrical conductivity: 6,000 S/cm) properties. In particular, graphene has been incorporated into polymer composites for improved barrier properties due to its excellent impermeability. However, several challenges, such as uniformity of graphene dispersion and its high manufacturing cost, prevent the widespread use of graphene for the polymer composite. For this reason, graphene nano-platelets (“GnPs”) have gained attention as a filler for polymer composites.

GnPs consist of 10-60 graphene layers and can be produced in a relatively easier and more economical way than single layer graphene. Furthermore, a higher degree of dispersion of GnPs within the composite can be achieved as compared to graphene. Commercialized PU and GnPs were used to fabricate PU/GnP composites. The prepared composites were applied as a coating on a copper (Cu) substrate as a protective layer against a corrosive media. In addition, four types of GnPs with different sizes were compounded with PU via planetary centrifugal mixer (“PCM”). The composites were analyzed in terms of various properties including mechanical and electrochemical properties. The corrosion behavior of the PU/GnP composites on the Cu substrate and the size effect of GnPs on the corrosion resistance in a corrosive media were studied. The corrosion resistance of the PU/GnP composites was improved by the existence of GnP and the smaller size of GnP led to the improvement of the anti-corrosion resistance from 97.5% to 99.6% in terms of the protection efficiency of the composites.

Highly flexible and abrasion resistant PU was used as a matrix material for the PU/GnPs. A resin (6401-1, viscosity: 50 cP) including 4,4′-Methylene diphenyl diisocyanate (MDI) with triethyl phosphate and a hardener (6401-2, viscosity: 1,300 cP) including oxyalkylene polymer with 1,4 butanediol as a chain extender were employed. The mixing ratio of resin and hardener was 25:100 by mass. The four grades of GnP were used as the filler. The grades of GnP used were xGnP H100, M25, M5, and C750, and were distinguished by the average diameter corresponding with a size of GnP and surface area. Grade H100 has an approximate diameter of 150 μm with a typical surface area of 50 to 80 m²/g. The average diameters of M25 and M5 are 25 and 5 μm, respectively, with typical surface areas of 120 m²/g and 150 m²/g, respectively. C750 has the smallest diameter under 2 μm with the average surface area of 750 m²/g. The density of all grades are 2.2 g/cm³. Table 5 summarized the basic physical properties of commercialized GnPs.

TABLE 5
Physical properties of commercialized GnPs used in this study

| | | Surface | |
|---|---|---|---|
| | Diameter | Area | Density |
| Grade of GnPs | (μm) | (m²/g) | (g/cm³) |
| xGNP H100 | 150 | 50~80 | 2.2 |
| xGNP M25 | 25 | ~120 | 2.2 |
| xGNP M5 | 5 | ~150 | 2.2 |
| xGNP C750 | <2 | ~750 | 2.2 |

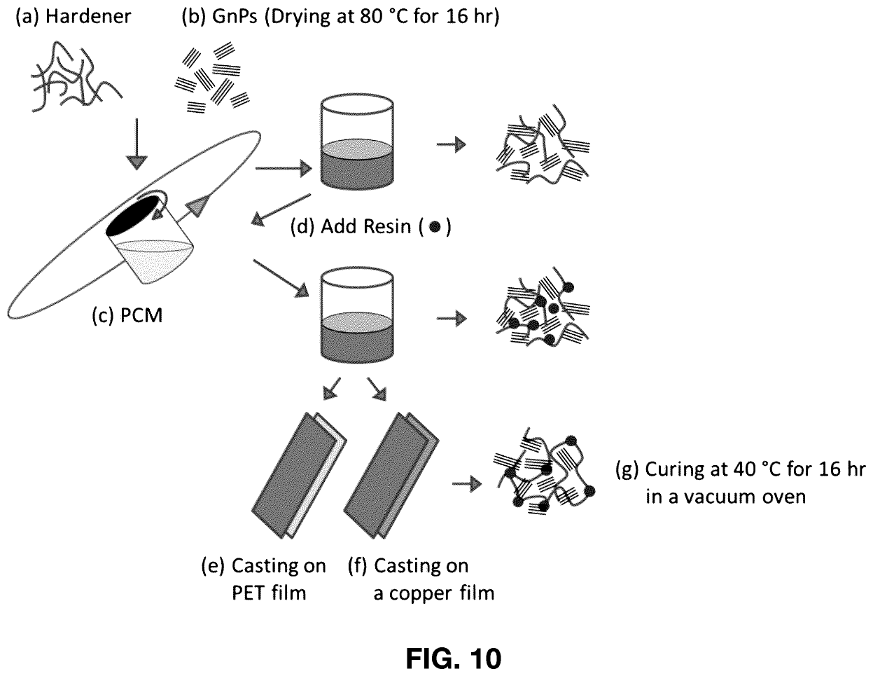

The different GnPs (H100, M25, M5 and C750) were dried in a vacuum oven at 80 degrees Celsius for 16 hours to remove moisture and then dispersed in hardener at various mass loadings (0, 0.5 [25 mg], 1.0 [50 mg], 3.0 [150 mg] and 6.0 [300 mg] wt %) using a PCM (YS-2E, China) for 40 minutes. Resin was added to the mixture of hardener and GnPs with a resin:hardener ratio of 25:100 by mass, and the mixture was mixed for 10 minutes. The final mixtures were cast on clean polyethylene terephthalate (“PET”) substrates (thickness: 100 μm) and polished Cu substrate (thickness: 30 μm). A 300 μm film was cast using an adjustable film applicator (width: 76 mm). The film was then pre-cured at room temperature for 2 h to form a skin layer and cured completely in a vacuum oven at 40 degrees Celsius for 16 hours. The cured film on the PET substrate was peeled off for mechanical testing whereas the film on the Cu substrate remained intact and was used directly for electrochemical measurements. The process of sample preparation is schematically illustrated in FIG. 10.

Samples were characterized by XRD using Cu-Ka radiation (λ=1.54184 nm). The samples were scanned from 2θ=1 degree to 80 degrees at a rate of 1 degreee/minute. The acquired spectra were used to calculate the crystallite size and thickness of GnPs, based on the Debye-Scherrer equation (Equation 2):

$$T = \frac{K λ}{β cos θ} \qquad ( 2 )$$

where β is the full width at half maximum (FWHM, radian), λ is the radiation wavelength used for measurement, K is the shape constant of 0.9, and θ is the diffraction angle. The relative size of the GnPs was obtained from the calculations and compared with the reported values of each grade of GnP.

The morphology of GnP and PU/GnP was characterized by the SEM. A cross-sectional sample of PU/GnP for SEM was prepared by cryogenic rupture using liquid nitrogen, and samples were gold-sputtered prior to imaging.

Mechanical properties of PU/GnP were characterized by a universal testing machine (“UTM”) at room temperature at a cross-head rate of 100 mm/min. Five samples, fabricated with a length of 75 mm, thickness of 300 μm, and a parallel length of 30 mm, were measured based on ASTM D638. Tensile modulus was calculated by the initial linear slope of the entire stress-strain curve, tensile strength corresponded with the maximum strength, and elongation at break was determined by strain at sample fracture.

Electrochemical properties of PU/GnP were measured using the standard corrosion cell consisting of a circular Teflon sample holder in a double-jacketed glass cell (1 L). The corrosion cell contained a three electrode system that consisted of a coated or uncoated Cu disk specimen (Area: 1 cm²) assigned as a working electrode (“WE”), two graphite rods as a counter electrode (“CE”), and a Ag/AgCl electrode as a reference electrode (“RE”).

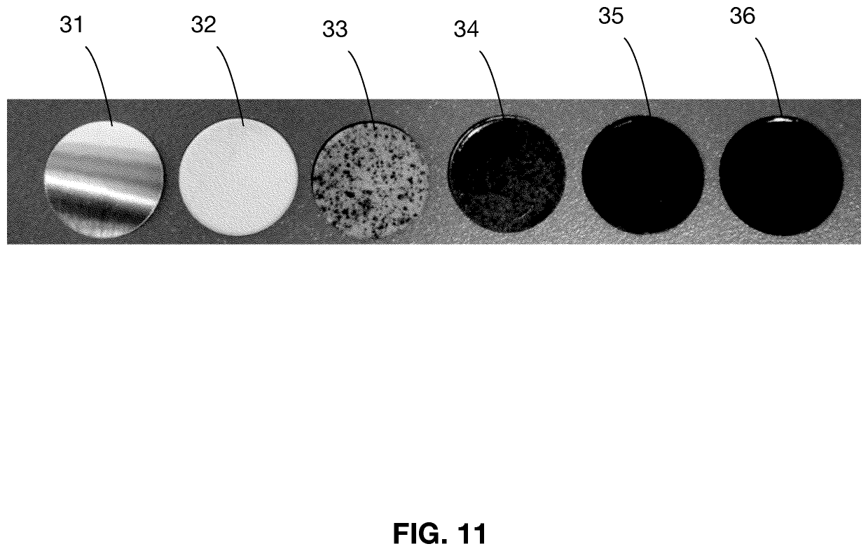

FIG. 11 illustrates the Cu specimens, including pristine Cu and Cu cast with the PU/GnP composites. In particular, shown are a pristine Cu disk 31, a pristine PU on Cu disk 32, a PU/H100 on Cu disk 33, a PU/M25 on Cu disk 34, a PU/M5 on Cu disk 35, and a PU/C750 on Cu disk 36. The GnP loading for all composites here is 1 wt %.

The film on the Cu showed different color depending on the grade of GnP. The PU/GnP film containing H100 showed sporadic dispersion of GnPs owing to the large size of H100, while the PU/GnP containing M5 and C750 showed relatively uniform dispersions of GnP.

The corrosion sample was cleaned by deionized water and dried before mounting the sample holder. The double-jacketed glass cell was filled with 3.5 wt % NaCl electrolyte solution under room temperature. Electrochemical analysis was conducted, with each measurement was repeated five times for a reproducibility.

The WE was stabilized for three hours to four hours to minimize the fluctuation of the potential before performing EIS followed by potentiodynamic measurements or cyclic voltammetry (CV). EIS was conducted in a frequency range from 100 kHz to 200 Hz to obtain Nyquist and Bode plots. CV was conducted to obtain Tafel polarization curves by scanning at a rate of 20 millivolts/minute in the potential range from −500 millivolts to 500 millivolts. The Tafel plot was used to determine the corrosion current (I_{corr}) by extrapolating the linear portion of the anodic and cathodic curves.

The corrosion rate (R_{corr}), in units of mils per year (MPY), was determined by the following Equation 3 as described in the ASTM standard G102:

$${R}_{c o r r} = \frac{0.13 \times {I}_{c o r r} \times E W}{A \times ρ} \qquad ( 3 )$$

where EW is the equivalent weight of a copper (31.7 g), ρ is the density of the copper (8.97 g/cm³), and A is the surface area of the sample (1 cm²).

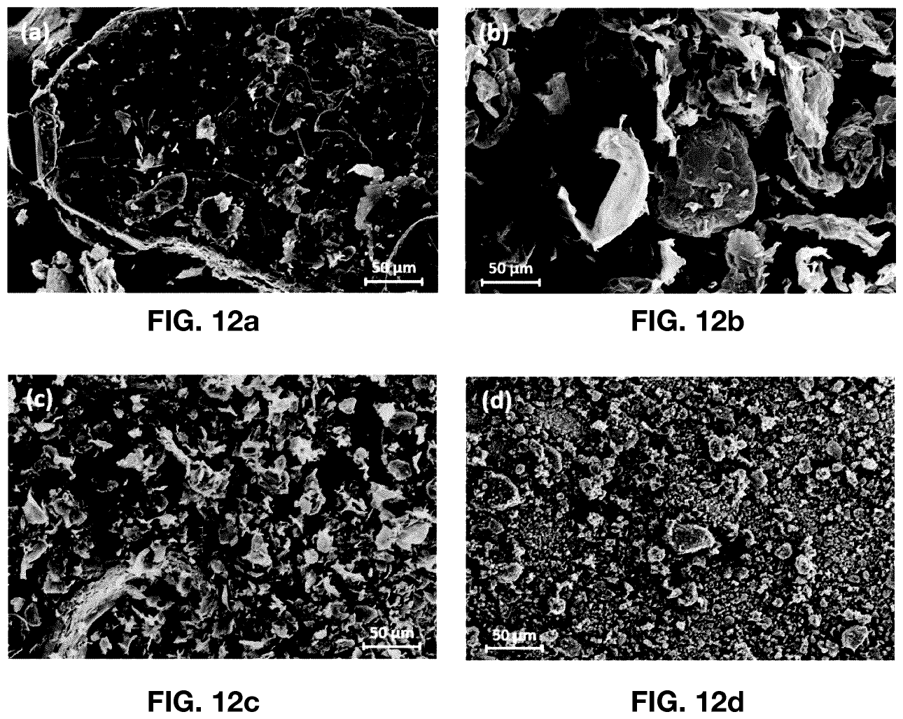

SEM images of the different grades of pristine GnPs are illustrated in FIGS. 12a to 12d under the identical magnification for the exact comparison of GnP size. In particular, FIG. 12a shows xGnP H100, FIG. 12b shows xGnP M25, FIG. 12c shows xGnPs M5, and FIG. 12d shows xGnPs C750. The images reveal that the diameter of each GnP matches the reported average diameter from the manufacturer, while the actual size distribution of the samples are broad in appearance. Nevertheless, the SEM images clearly show the distinct differences in size between the four grades of GnP.

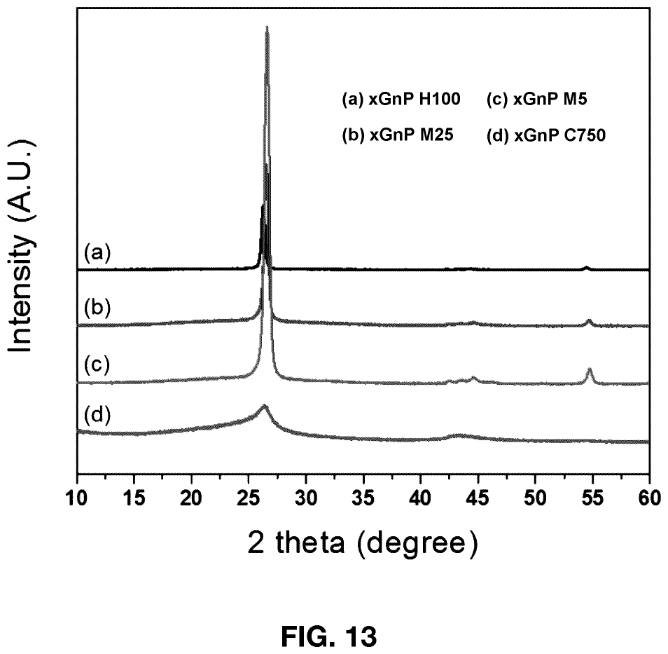

An XRD spectrum of each GnP is presented in FIG. 13 and the calculated parameters of the GnPs from the XRD spectra are summarized in Table 6. The three grades of GnPs (excluding C750) show a comparable XRD spectrum in terms of the position and breadth of the peak (2θ=26°). The d-spacing, or interlayer distance between graphene sheets, was calculated to be 3.35˜3.38 Å for the three grades using Bragg's equation. The number of graphene layers, indicative of the crystallite size of the GnPs, was calculated as 62 (H100), 56 (M25), and 58 (M5). On the other hand, C750 shows a relatively broad spectrum and low intensity as compared to other three grades of GnPs, and the number of layers calculated to be 13. For this reason, the aspect ratio, defined as the ratio of the average diameter (L) and the thickness of GnP (D), is not proportional to the size of GnP, especially for C750 and M5. In addition, the bulk density of C750 was significantly larger than the other grades of GnPs. Due to the higher bulk density and less number of layers of C750, a greater number of particles can be dispersed in a unit volume at the same sample weight of GnP. Therefore, it can be assumed that higher degree of dispersion is achievable with C750 than with the other grades of GnP.

TABLE 6
Parameters extracted from XRD spectrum
and provided from the manufacturer

| | | | Number of | Bulk | Aspect |
|---|---|---|---|---|---|
| | FWHM | d-spacing | graphene | Density | ratio |
| GnPs Grade | (rad, ×10⁻³) | (Å) | layers | (g/cc) | (L/D) |
| H-100 | 6.76 | 3.38 | 62 | 0.03~0.1 | 4032.3 |
| M-25 | 7.54 | 3.36 | 56 | 0.03~0.1 | 1116.1 |
| M-5 | 7.31 | 3.35 | 58 | 0.03~0.1 | 215.5 |
| C-750 | 33.12 | 3.37 | 13 | 0.2~0.4 | 384.6 |

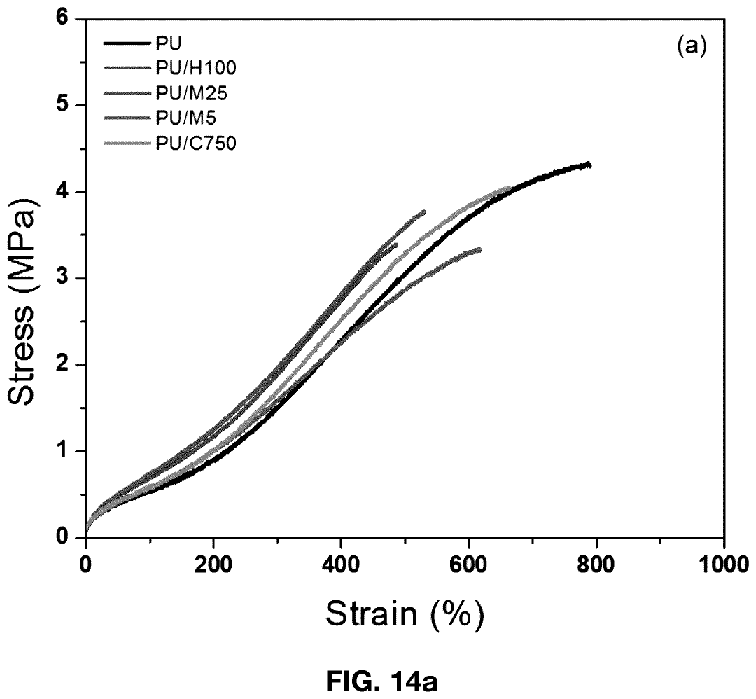

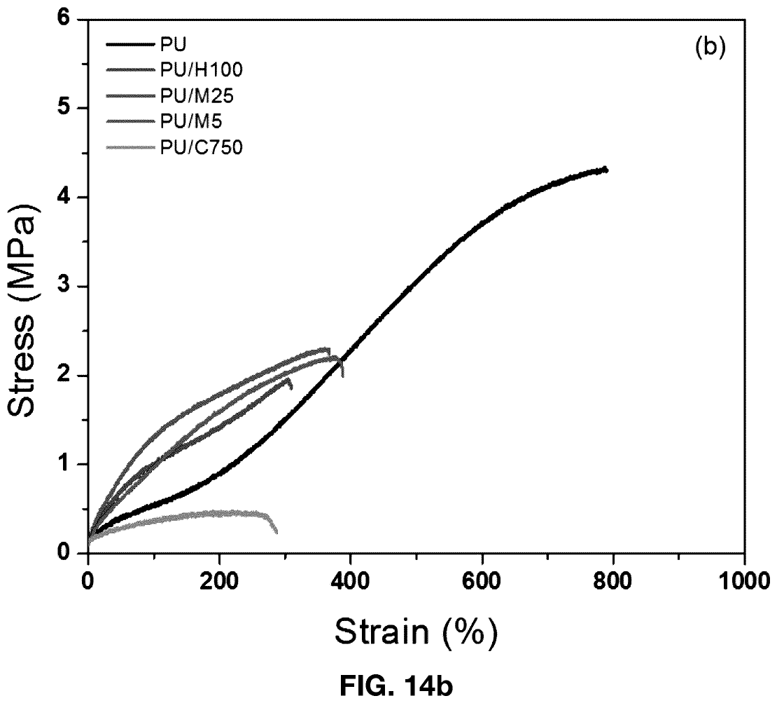

FIGS. 14a and 14b present the stress-strain curves of PU/GnP composites with a GnP loading of 1 wt % and 6 wt % respectively. The tensile modulus of the pristine PU corresponds with 0.85 MPa from the initial slope of the curve. On the other hand, the PU composites with 1 wt % GnP show a slightly steeper initial slope than the slope of the pristine PU and the tensile modulus of PU/H100, PU/M25, PU/M5, PU/C750 composites are 1.09 MPa, 1.07 MPa, 0.88 MPa, and 0.79 MPa, respectively. For a GnP loading of 6 wt % the initial slope is much steeper than with 1 wt %, changing the tensile modulus of the PU/H100, PU/M25, PU/M5, and PU/C750 composites to 1.60 MPa, 1.87 MPa, 1.35 MPa, and 0.20 MPa, respectively. As the GnP loading increases, the tensile modulus of the PU/GnP composite increases. The exception to this trend is found in PU/C750, where the tensile strength and elongation at break decreases. The tensile properties of the composites do not exhibit any distinct variation with respect to the size of the GnP. It is assumed that an interfacial adhesion between the PU matrix and GnP is insufficient to uniformly transfer external stress throughout the whole composite. A lack of strong interfacial bonding often results in a defect causing an early rupture of the tensile specimen during the extension process. To improve the interfacial interaction between PU and GnP, the chemical treatment of the surface of GnP has been of interest. For example, it has been found that thermoplastic polyurethane reinforced with isocyanate-treated graphene oxide (TPU/iGO) showed 250% improvement in tensile modulus even at much lower loadings than with untreated graphene because the chemical reaction and subsequent strong interfacial bonding between iGO and TPU. In addition, it has been found that poly(vinyl alcohol) composites including graphene oxide (PVA/GO) showed improvements of 76% and 62% in tensile strength and tensile modulus, respectively, as strong hydrogen bonding between PVA and GO contributed to the improved distribution of the external stress across the composite. In the GnPs tested, tensile strength and elongation at break of PU/GnPs are not improved by adding GnP due to the deficient interfacial adhesion between PU and GnP. In order to estimate the variation of mechanical properties with respect to the size of GnP, a prediction model is used to calculate the mechanical property variations of the composites. The calculated data by the Halpin-Tsai equation were compared with the experimental data.

The Halpin-Tsai equation is a general model to predict the tensile modulus of a composite proposed by Halpin and Tsai in 1976. This prediction model requires the aspect ratio of filler in the composite and the intrinsic elastic modulus of the filler and matrix polymer. The Halpin-Tsai equation for the composite with GnP is given by Equation (4):

$$\begin{matrix}{E}_{c} = {E}_{m} [ \frac{3}{8} \frac{1 + {η}_{L} ξ {V}_{C}}{1 - {η}_{L} {V}_{C}} + \frac{5}{8} \frac{1 + 2 {η}_{T} ξ {V}_{C}}{1 - {η}_{T} {V}_{C}} ] & ( 4 ) \\ {η}_{L} = \frac{( {E}_{g} / {E}_{m} ) - 1}{( {E}_{g} / {E}_{m} ) + ξ} & ( 5 ) \\ {η}_{T} = \frac{( {E}_{g} / {E}_{m} ) - 1}{( {E}_{g} / {E}_{m} ) + 2} & ( 6 ) \\ ξ = \frac{2}{3} {α}_{g} = \frac{2}{3} \frac{{l}_{g}}{{t}_{g}} & ( 7 )\end{matrix}$$

where E_{c} is the tensile modulus of the composite calculated by Halpin-Tasi equation, E_{g} and Eₘ are the elastic modulus of GnP and a polymer matrix, respectively. a_{g}, I_{g}, and t_{g} are the aspect ratio, length (diameter) of GnP, and the thickness of GnP, respectively.

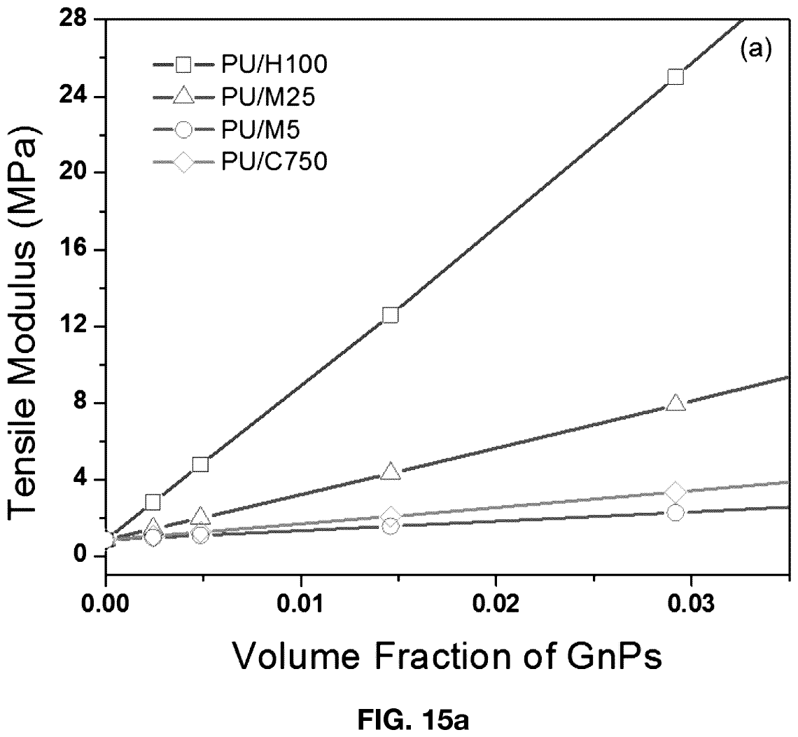

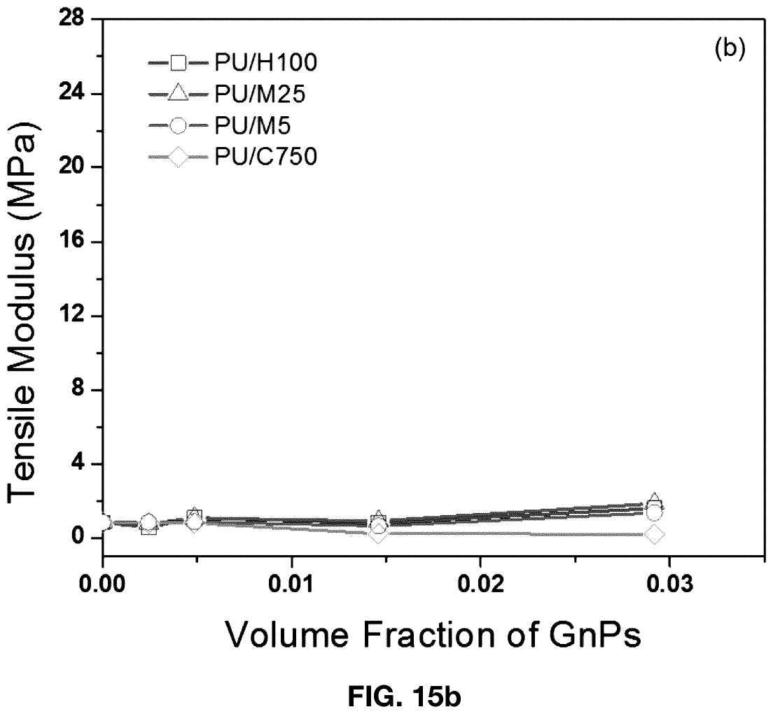

FIGS. 15a and 15b illustrate the prediction result of the Halpin-Tsai equation and the experimental result for PU/GnP as a function of volume fraction of GnP. FIG. 15a shows the tensile modulus of the composite using the Halpin-Tsai equation. The tensile modulus strongly depends on the type of GnP and its aspect ratio. The PU/H100 composite in FIG. 15a presents a steeper slope than the other composites, indicating that the mechanical properties of the composite should improve as the size of GnPs increases under the assumption of identical interfacial bonding between PU and GnPs. On the other hand, the PU/C750 composite shows slightly higher slope than PU/M5 composite although the size of C750 is smaller than M5. This is because the aspect ratio of C750 is larger than M5 due to the lower number of layers in C750. However, FIG. 15b, the experimental results of the composite in tensile modulus, illustrates that no significant trend regarding the types of GnP was observed. The lack of a trend could be possibly due to the absence of interfacial interaction between PU and GnPs. Nonetheless, it should be noted that the experimental curves of PU/GnPs with small aspect ratio GnPs (e.g., M5 and C750) coincided relatively well with the predicted Halpin-Tsai model. Therefore, the Halpin-Tsai equation is likely to be more applicable to PU/GnP composites incorporated with low aspect ratio GnP.

Cyclic voltammetry (“CV”) is widely used to quantify the corrosion resistance of a coated or uncoated metal substrate. In general, a Tafel polarization curve and anti-corrosion performance of a material is evaluated by the value of the potential and current. For instance, higher potential and lower current value correspond with high corrosion resistance.

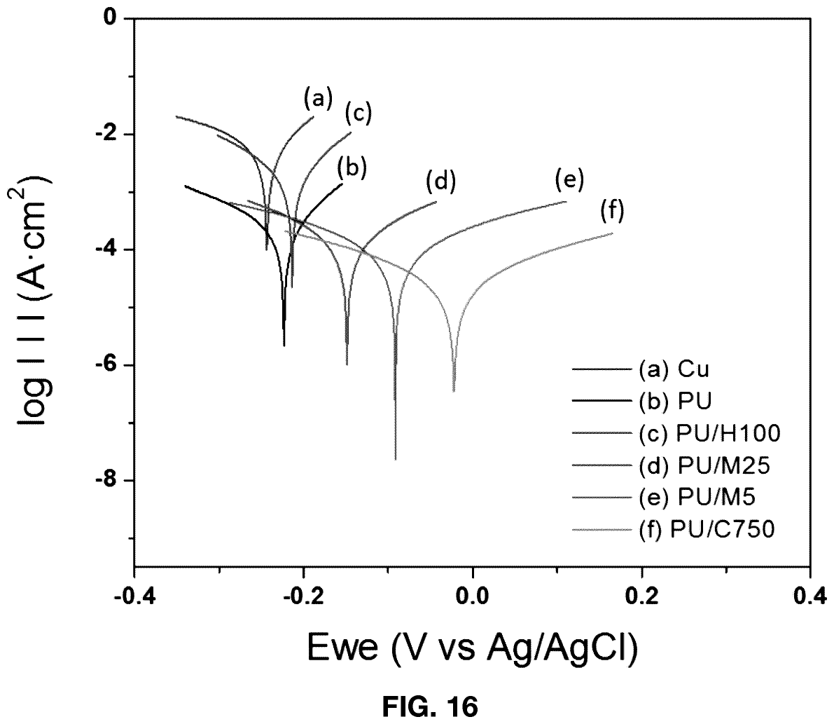

FIG. 16 illustrates Tafel plots for pristine Cu and the Cu coated with PU and the PU/GnP composites with GnP loading for all samples at 1 wt %. The plots reveal that PU/GnP with smaller diameter of GnP shifts the polarization curve to a larger potential and smaller current. This means that the smaller size of GnP in the composites improves the anti-corrosion performance of PU/GnP. Furthermore, the Tafel plot provides significant parameters such as corrosion potential (E_{corr}) and corrosion current (I_{corr}) to quantify the corrosion resistance of the composites. The parameters are determined by the point of intersection between extrapolated cathodic and anodic curves. Furthermore, Rₚ, polarization resistance, is calculated by using Stern-Geary equation (Equation 8), where constants bₐ and b_{c} represent the anodic and cathodic slope in the Tafel plot, respectively. In this equation, a smaller Rₚ values represents a higher corrosion resistance. All calculated parameters are shown in Table 7.

$${R}_{p} = \frac{{b}_{a} \times {b}_{c}}{2.303 \times ( {b}_{a} + {b}_{c} ) \times {I}_{c o r r}} \qquad ( 8 )$$

The results show that as the size of GnP decreases, E_{corr} increases while I_{corr} decreases. This means that the smaller size of GnP requires a higher corrosion potential to corrode the Cu and a lower current is detected in the potentiodynamic electrochemical system. However, it should be noted that the I_{corr} value of PU/H100 is higher than with pristine PU, resulting in a lower Rₚ value and higher corrosion rate (R_{corr}). This unexpected variation may be due to the thickness of the PU/H100 layer on Cu. For instance, Qi et al. reported that the lower thickness of the film led to a higher corrosion current with an unchanged corrosion potential. However, PU/H100 was cast on the Cu substrate with the thickness same as PU (300 μm). For this reason, it can be assumed that there is a cause to reduce the thickness of the cast film such as a crevice on the film surface, thus the black dots on the film of the PU/H100 specimen 33 in FIG. 11 are probably one of the causes. The black dots can supply a pathway at which a corrosive agent is easy to permeate into the film inside. It means that this phenomenon can result in decreasing the permeation rate of the agent same as reducing the thickness of the cast film.

TABLE 7
Electrochemical parameters from potentiodynamic measurements

| | E_{corr} | | | | | | |
|---|---|---|---|---|---|---|---|
| | (mV vs. | I_{corr} | bₐ | b_{c} | Rₚ | R_{corr} | P_{EF} |
| Samples | Ag/AgCl) | (μA/cm²) | (mV/dec) | (mV/dec) | (Ω · cm²) | (MPY) | (%) |
| Cu | −243.5 | 12.55 | 150.0 | 431.9 | 3.9 | 5.71 | — |
| PU | −223.6 | 0.31 | 100.5 | 193.1 | 92.0 | 0.14 | 97.5 |
| PU/H100 | −213.8 | 2.47 | 103.7 | 146.3 | 10.7 | 1.13 | 80.3 |
| PU/M25 | −149.0 | 0.24 | 214.3 | 235.4 | 199.6 | 0.11 | 98.1 |
| PU/M5 | −91.6 | 0.12 | 354.7 | 356.2 | 389.8 | 0.09 | 98.4 |
| PU/C750 | −22.0 | 0.05 | 300.0 | 302.7 | 1363.0 | 0.02 | 99.6 |

The protection efficiency (P_{EF}) obtained from the Tafel plot is also widely used as a metric to evaluate the anti-corrosion performance of a protective layer on a metal substrate and given by Equation 9:

$${P}_{E F} [ \% ] = ( 1 - \frac{{I}_{corr}}{{I}_{corr}^{°}} ) \times 100 \qquad ( 9 )$$

where I°_{corr} represents the corrosion current of the pristine PU. Table 7 also shows that P_{EF} increases by incorporating smaller sizes of GnP in the PU/GnP layer, indicating that the anti-corrosion performance of PU/GnP is enhanced with smaller sizes of GnP. However, the P_{EF} value of PU/H100 is lower than that of the pristine PU due to its relatively higher I_{corr} value.

In addition, EIS was also used to quantify the anti-corrosive performance.

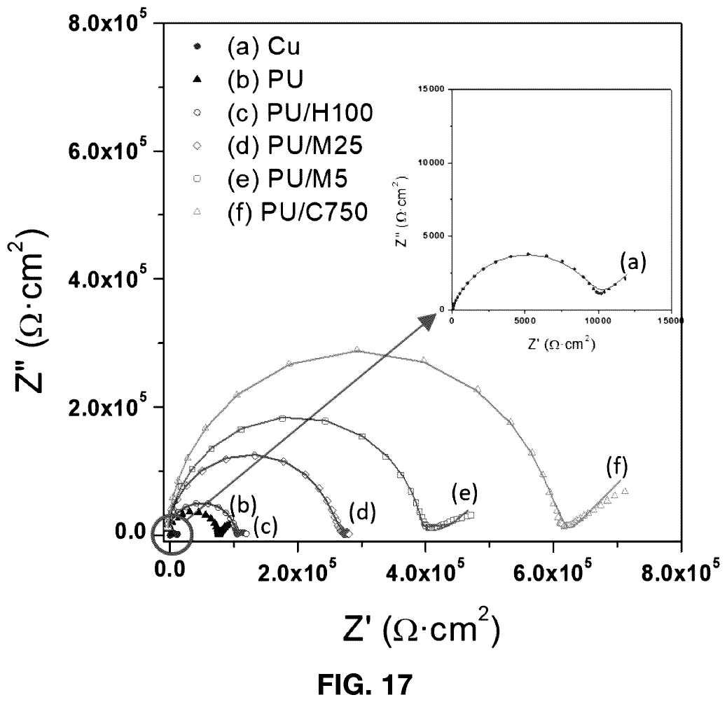

FIG. 17 illustrates the Nyquist plot (GnP loading for all samples: 1 wt %) for the pristine Cu and PU/GnP on Cu. The measured EIS (dotted line) data is fitted with the appropriate equivalent circuit model (solid line). The feature of interested in these Nyquist plots is the diameter of the semicircle. A larger semicircle diameter corresponds with a larger resistance, which is inversely proportional to I_{corr}, indicates high anti-corrosion performance. The EIS spectrum of the Cu substrate in FIG. 17 shows the typical curve, and the pristine PU on Cu clearly shows a larger semicircle than the pristine Cu. This means that the corrosion resistance of Cu is improved by the PU layer alone. However, the PU/GnP composites show much larger semicircles than the pristine PU, thus GnP highly contributes to the improvement of the corrosion resistance of the composites. PU/GnP with the smaller size of GnP shows the larger diameter of the semicircle in Nyquist plot. Nevertheless, the diameter of PU/H100 is slightly larger than that of the pristine PU, which is in line with the CV measurement.

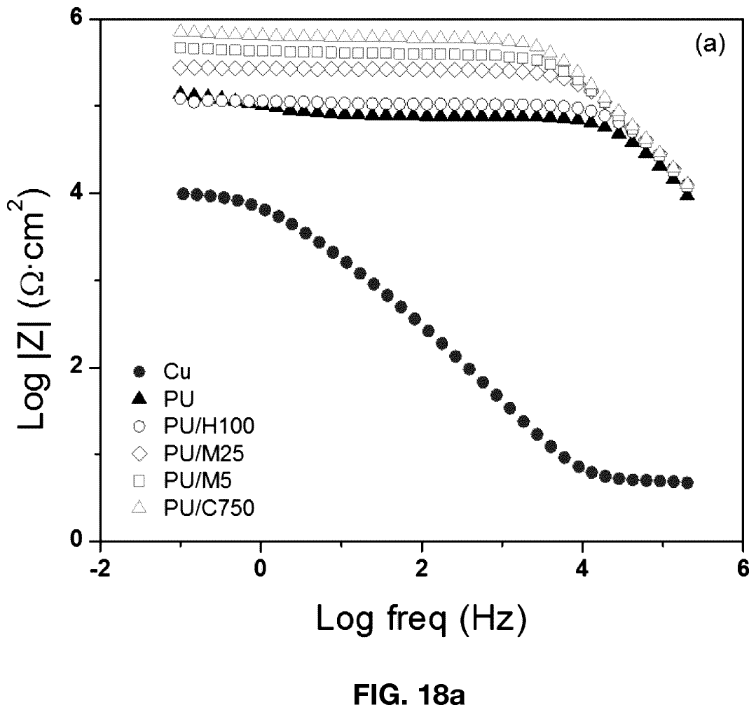

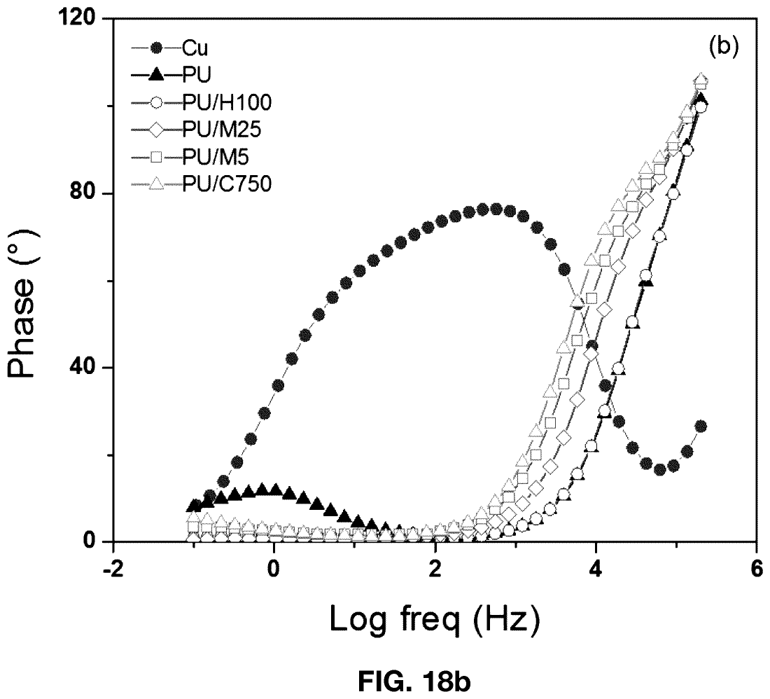

To supplement the Nyquist plot, Bode plots were also used to compare the anti-corrosion performance of PU/GnP. FIGS. 18a and 18b illustrate the Bode plot and the phase plot respectively for the pristine Cu and PU/GnP on Cu (GnP loading for all samples: 1 wt %). In FIG. 18a, the Zᵣₑₐₗ value at the lowest frequency represents the corrosion resistance, thus the larger value of Zᵣₑₐₗ leads to a smaller I_{corr} and higher corrosion resistance. The Bode plot shows the distinct tendency for smaller sizes of GnP in the composite to produce larger Zᵣₑₐₗ values at the lowest frequency. PU/H100 shows a slightly lower Zᵣₑₐₗ value (5.09 Ω.cm²) than the pristine PU (5.14 Ω.cm²), however, the difference is not large enough to assume and difference in corrosion resistance. As a result, the Bode plot also confirms that H100 does not contribute to improving the corrosion resistance of the composite.

The corrosion resistance of the composites is definitely improved by decreasing GnP size, whereas H100, the largest size of GnP, does not follow this trend. It is assumed that this results is related to the phenomenon regarding the lack of an interfacial bonding between H100 and PU mentioned above.

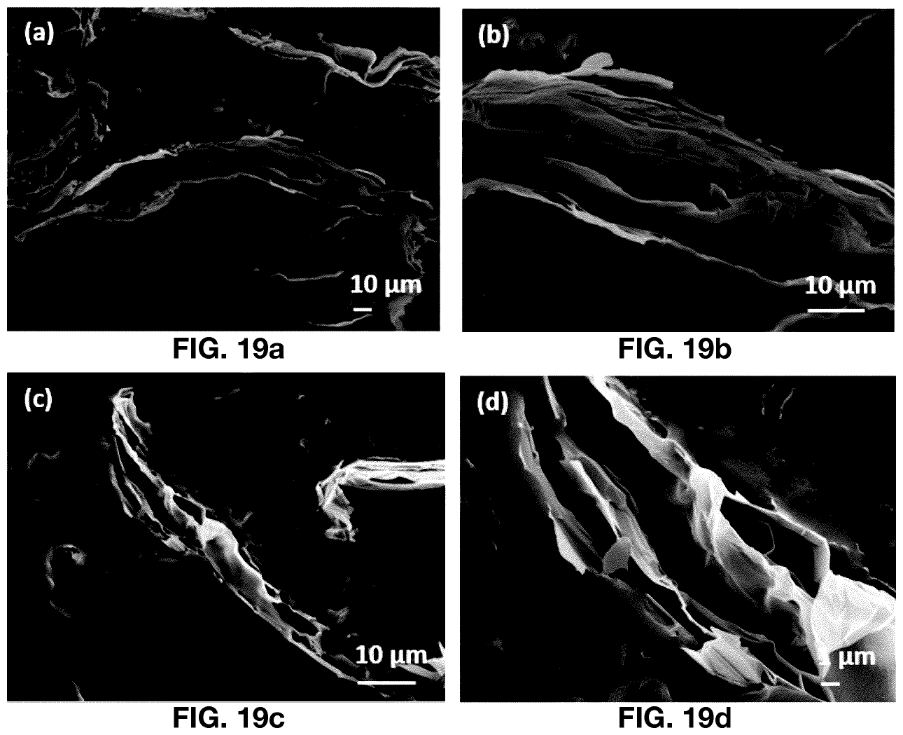

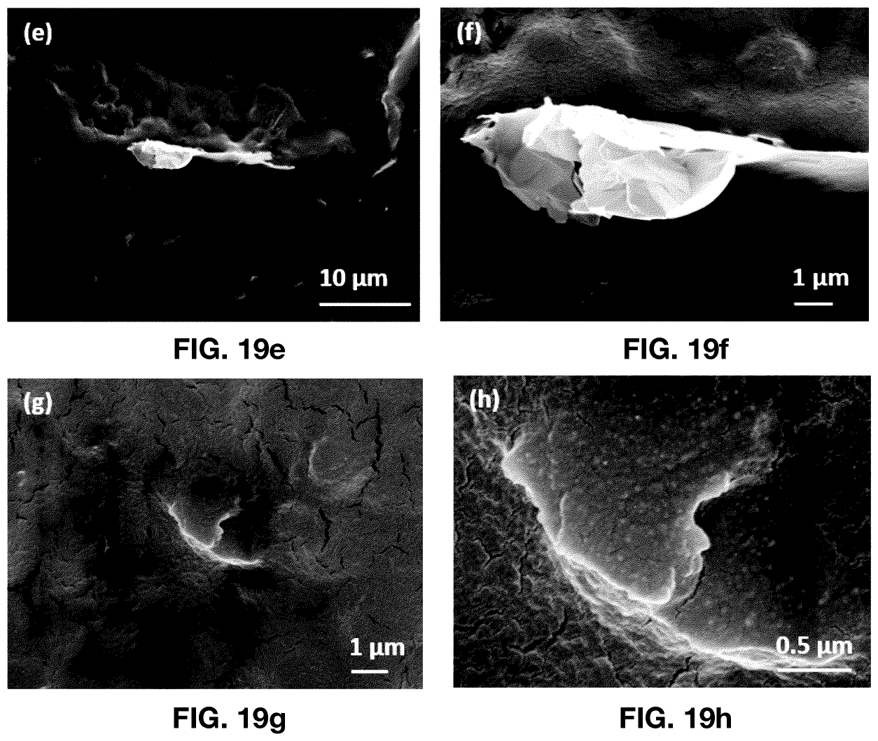

FIGS. 19a to 19h shows the cross-sectional morphology of various PU/GnP composites with a loading of 1 wt % using a SEM. In particular, FIGS. 19a and 19b show the cross-sectional morphology of PU/H100, FIGS. 19c and 19d show the cross-sectional morphology of PU/M25, FIGS. 19e and 19f show the cross-sectional morphology of PU/M5, and FIGS. 19g and 19h show the cross-sectional morphology of PU/C750. Each type of GnP is readily dispersed in PU and show their intrinsic size. An exfoliation of GnP or intercalation by PU is not observed. Furthermore, relatively large GnPs, such as H100 and M25, are easily observed and show a detached space among the GnPs. However, the small GnPs, such as M5 and C750, are dispersed within the polymer matrix and the detached layers within GnPs are not observed. Based on this observation, it can be assumed that the larger size of GnP occupy a larger domain in the polymer matrix and smaller number of GnP particles are distributed in the composite for the same loading of GnP.

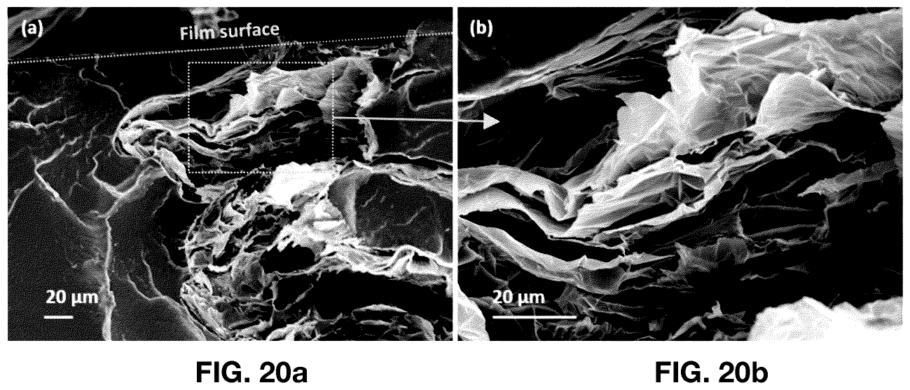

Furthermore, FIGS. 20a and 20b reveal that PU/H100 shows a void between the PU matrix and GnP near the surface of film. This void allows a corrosive agent to easily diffuse into PU/H100 composite from the surface. For this reason, large H100 particles reduce the anti-corrosion performance of the PU/GnP layer because as the corrosive agents pass through the voids, the path length for corrosive agent is reduced. However, PU/M5 and PU/C750 show a uniform dispersion of GnP in the PU matrix without voids. Therefore, small GnPs are likely to provide a relatively more complicated pathway for corrosive agents than large GnPs. Furthermore, the voids generated due to large GnPs can also reduce the mechanical properties of PU/GnP since the strength of interfacial adhesion is proportional to the contact area among PU and GnP. The Halpin-Tsai model also reveals that the tensile modulus of PU/H100 showed the largest deviation between the experimental data and the estimated values owing to the voids present in PU/H100.

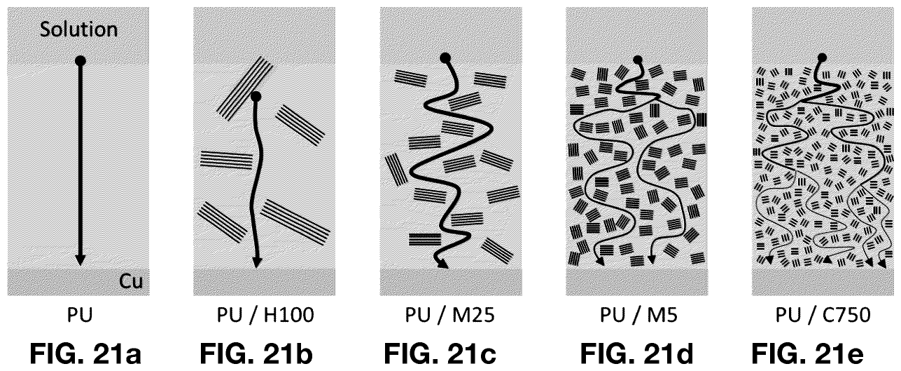

FIGS. 21a to 21e depict a schematic mechanism for the size effect of GnP with regards to the corrosion resistance of PU/GnP containing 1 wt % GnP for PU, PU/H100, PU/M25, PU/M5, and PU/C750 respectively. FIGS. 21a to 21e suggest that the smaller GnPs are well-dispersed within the composite and provide more complicated pathway for the corrosive agent. Thus, the time taken for the corrosive agent to reach the Cu substrate is extended.

PU/GnP composites were fabricated via planetary centrifugal mixer with GnP contents of 0.5 to 6 wt % (0.0024 to 0.0292 vol %). SEM and XRD confirmed the difference in average diameter and size distributions between the four grades of GnP. The size difference among the four grades was distinct enough to evaluate the size effect of GnP on the mechanical and anti-corrosion properties of the PU/GnP composites. The tensile modulus of the composite increased from 0.85 MPa to 1.87 MPa whereas tensile strength and elongation at break reduced as the size of GnPs increased (with the exception of PU/C750). This is because GnP contributes to improving the tensile modulus of the composites during the initial extension of the entire tensile process but the elongation at break eventually decreased by the existence of GnPs and the tensile strength of the composites was also reduced. The Halpin-Tsai equation model revealed that the tensile modulus of the composites linearly increased with the volume content of GnP but decreased as the size of GnP decreased. However, the prediction model did not coincide with the experimental data. In particular, the PU composite incorporated with H100 showed the greatest deviation between modeled and experimental values. It is assumed that the Halpin-Tsai prediction is strongly dependent on the aspect ratio of filler and based on an ideal interfacial adhesion between PU and GnP. CV was performed to obtain the Tefal plot to quantify the anti-corrosion performance of the PU/GnP composites. In the Tafel plot, E_{corr} and I_{corr} of pristine PU were −223.6 mV and 0.31 μA/cm², respectively. E_{corr} of the composite increased up to −22.0 mV, and I_{corr} declined to 0.05 μA/cm² by reducing the size of GnP. Furthermore, the protection efficiency (P_{EF}) increased up to 99.6%. Nyquist plots revealed that the PU composite including smaller sized GnPs showed a larger semicircle, and the Zᵣₑₐₗ value in the corresponding Bode plot increased from 5.14 Ω·cm² (pristine PU) to 5.85 Ω·cm². These results clearly indicate that anti-corrosion performance of PU/GnP is influenced by the size of GnP and improved by decreasing the size of GnP. SEM images showed that a higher degree of dispersion was obtained when the smaller GnPs was used due to having a greater bulk density. This supports the theory that the small GnPs in the PU composite supply more convoluted pathways for corrosive agents to diffuse, extending the diffusion time. On the other hand, the large GnPs create voids between PU and GnPs, reducing the anti-corrosion performance and mechanical properties. Clearly, the smaller GnPs improve the anti-corrosion performance of PU/GnPs, and this is illustrated the schematic model.

Graphene oxide (“GO”) also improves the coating characteristics of PU. It provides enhanced mechanical properties, including tensile, flexural, abrasion, and hardness properties. Further, graphene oxide improves the corrosion resistance of PU.

GO is an oxidized form of graphite and water dispersible form owing to oxygen containing functional groups.

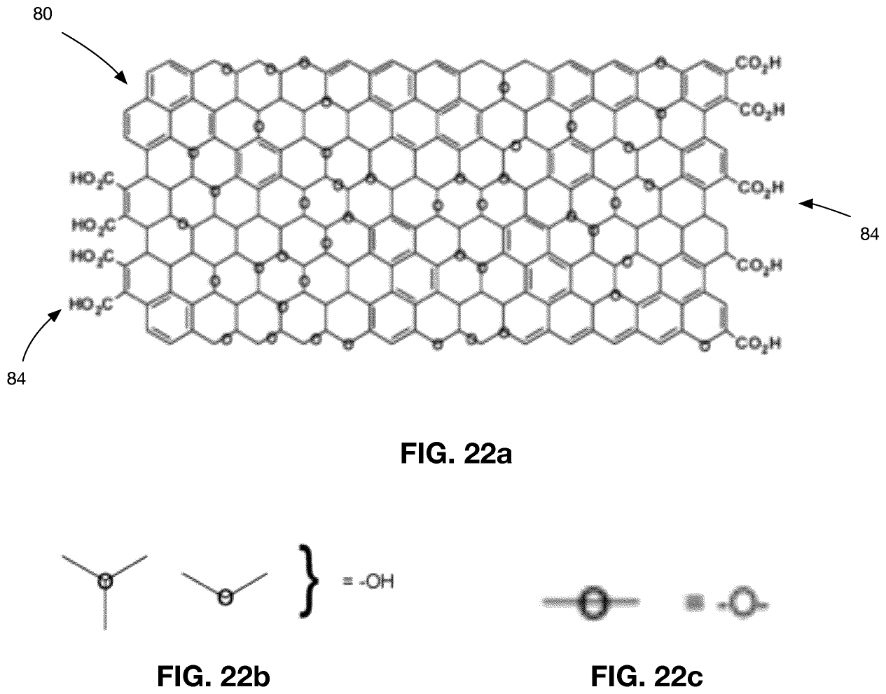

FIG. 22a shows a GO chemical structure 80 (Lert-Klinowski model). GO includes hydroxyl functional groups (FIG. 22b) and epoxide functional groups (FIG. 22c) on the GO planes, and carboxyl functional groups 84 and carbonyl functional groups on the edge of GO sheets. GO structures like the GO chemical structure 80 interact with each other by hydrogen bonding. Interfacial adhesion can be improved in polymer/graphene composites by chemical modification using organic groups such as amine and isocyanate.

Polymer/GO composites can lead to improved overall properties of the composites due to better dispersion and interfacing between the chemicals. These properties enable the composite to serve as a coating material, and to provide improved gas barrier properties.

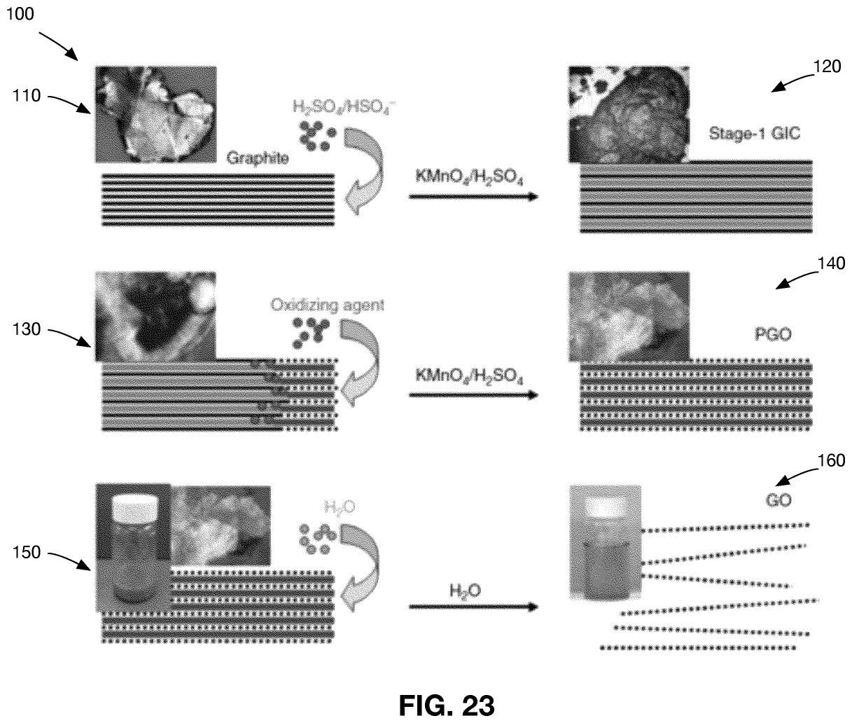

FIG. 23 shows the formulation 100 of GO via a chemical reaction with strong oxidants in concentrated acid media via Hummer's method. Raw graphite is treated with sulfuric acid/hydrogen sulfate (110), and then potassium permanganate is introduced to form a graphite intercalated compound (“GIC”) with sulfuric acid (120). An oxidizing agent is used to oxidize the GIC (130) to convert the GIC to pristine graphene oxide (“PGO”) (140). Water then is added (150) to convert the PGO to GO (160) by the reaction of the PGO with the water.

Various methods for the production of polymer/GO composites have been proposed. One method is solution compounding, which is simple, but the removal of a solvent can sometimes be important. In-situ polymerization provides a good dispersion and interaction of GO but it can sometimes be important to control the viscosity of the composites. Melt mixing is another approach that can be appropriate for thermoplastic. Layer-by-layer assembly can make it easy to control the thickness of multi-layer thin film but is better suited to a small scale process.

Tests were run on commercialized PU, both alone and combined with three different types of carbon-based filler to form composites. In particular, the commercialized PU tested was RenCast™ 6401 produced by Huntsman International LLC, with a mix ratio by weight percent of isocyanate:polyol of 50:100. The graphene nanoplatelets employed were 25 micron Grade M GnP from XG Sciences™ with an average diameter of 25 μm and a surface area of about 150 m²/g. The GO and the RGO were prepared in lab.

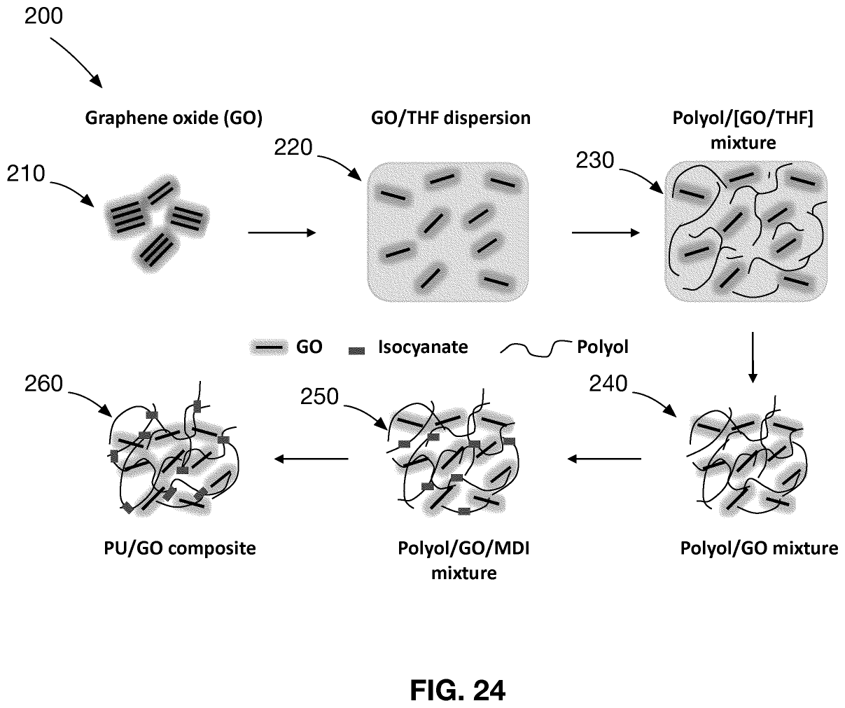

FIG. 24 shows the process of preparing the composites via in-situ polymerization generally at 200. GO (210) is dispersed uniformly with tetrahydrofuran (“THF”) via sonication to create a GO/THF dispersion (220). The GO/THF mixture was then mixed with polyol using a planetary centrifugal mixer to disperse GO uniformly into polyol to make a polyol/[GO/THF] mixture (230).

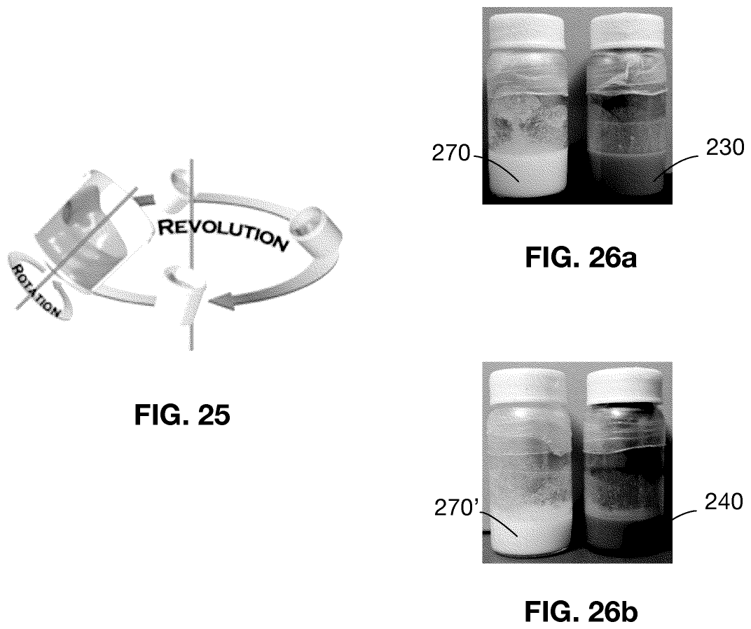

FIG. 25 shows the mixing action of the planetary centrifugal mixer used in the dispersion of GO into polyol. The planetary centrifugal mixer is useful for mixing highly viscous liquids, providing high uniformity in a short mixing time.

Returning again to FIG. 24, the THF is then evaporated, leaving a polyol/GO mixture (240). The polyol/GO mixture is then mixed with isocyanate via the planetary centrifugal mixer to create a polyol/GO/methylene diphenyl diisocyanate (“MDI”) mixture (250). The polyol/GO/MDI mixture is cured, resulting on a PU/GO composite (260). FIG. 26a shows a polyol/THF mixture 270 beside the polyol/[GO/THF] mixture 230 before removal of the THF via evaporation. As can be seen in FIG. 26b showing the polyol/THF mixture 270′ and the polyol/GO mixture 240 after evaporation of the THF. As can be seen, the GO remains uniformly dispersed in the polyol after removal of the THF.

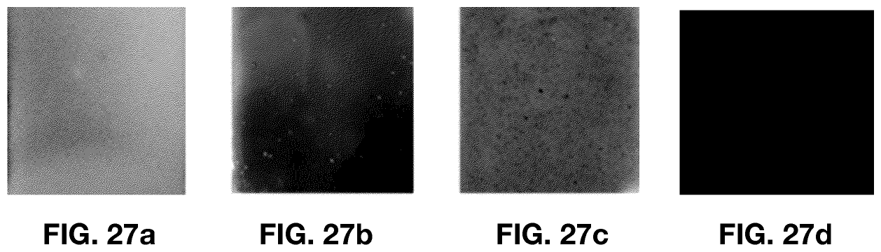

FIG. 27a shows RenCast 6401 alone (“neat”). FIG. 27b shows RenCast 6401 combined with GO (1% by weight) via solution mixing. As can be seen, no coagulation of the GO is evident. FIG. 27c shows RenCast 6401 combined with GO (1% by weight) via physical mixing. In this mixture, some coagulations of GO is visible. FIG. 27d shows RenCast 6401 combined with RGO (1% by weight) via physical mixing, wherein it appears that dispersion of the RGO is uniform.

Table 8 below summarizes multiple test results and shows the mechanical properties measured during the tests. As can be seen, the PU/GO composite has the highest elastic-modulus.

TABLE 8
Mechanical properties

| | | | Tensile | Elongation | |
|---|---|---|---|---|---|
| | Contents | E-Modulus | Strength | at break | |
| Samples | (wt %) | (MPa) | (MPa) | (%) | Note |
| Rencast 6401 | — | 14.7 ± 1.2 | 19 ± 0.3 | 203 | new type |
| PU/CNT-OH | 1 | — | 31 ± 1.7 | 192 | |
| PU/CNT-COOH | 1 | — | 26 ± 1.9 | 118 | |
| PU/f-CNT-COOH | 1 | — | 35 ± 2.4 | 286 | chemically |
| | | | | | functionalized |
| | | | | | commercial |
| | | | | | CNTs prepared |
| | | | | | in the lab |
| PU/GnP | 1 | 20 ± 1.7 | 12 ± 2.3 | 132 | xGnP M25 |
| PU/GO | 1 | 24.2 ± 0.9 | 17 ± 1.4 | 141 | GO from |
| | | | | | Graphite 2-15 |
| PU/RGO | 1 | 22.0 ± 1.8 | 20 ± 1.4 | 167 | thermal reduction |
| | | | | | of GO |
| Irathane (Orange | — | 23.2 ± 1.2 | 31 ± 0.4 | 249 | reference |
| layer) | | | | | |

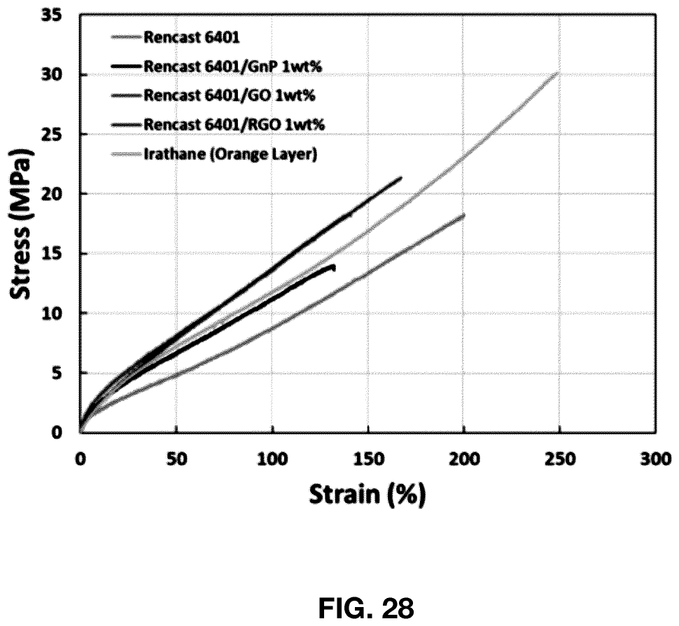

FIG. 28 shows a strain-stress curve, wherein the composite RenCast 6401/RGO (1% by weight) exhibited lower elongation in comparison to the other composites and commercialized PUs.

Table 9 below summarizes multiple test results and shows the hardness (Shore D) measured during the tests. As can be seen, it appears that there is no reinforcement effect by GnP or GO fillers in terms of hardness.

TABLE 9
Hardness (Shore D)

| | | Filler | | | | |
|---|---|---|---|---|---|---|
| | Type of | contents | Test | Shore D | Shore A | |
| Samples | filler | (wt %) | points | (Measured) | (Converted) | Note |
| RenCast 6401 | — | — | 6 | 39 | 90 | |
| PU/CNT-OH | CNT-OH | 1 | 5 | 39 | 90 | |
| PU/CNT-COOH | CNT-COOH | 1 | 5 | 40 | 90 | |
| PU/f-CNT-COOH | f-CNT-COOH | 1 | 5 | 40 | 90 | chemically |
| | | | | | | functionalized |
| | | | | | | commercial |
| | | | | | | CNTs prepared |
| | | | | | | in the lab |
| PU/GnP | xGnP M25 | 1 | 6 | 40 | 90 | |
| PU/GO | GO | 1 | 6 | 39 | 90 | |
| PU/RGO | RGO | 1 | 6 | 41 | 90 | |
| Irathane | — | — | 6 | 40 | 90 | Shore A: 91 |
| (Orange layer) | | | | | | (Irathane |
| | | | | | | report) |

Table 10 below summarizes multiple test results and shows that the CNT composites show better wear resistance than both GO and RGO composites, which show better wear resistance than neat PU. The wear resistance of the CNT composites, however, is very similar. The same can also be said for the GO and the RGO composites.

TABLE 10
Abrasion

| | | | Initial | After | Weight | Taber |
|---|---|---|---|---|---|---|
| | Load | | weight | testing | loss | index |
| Samples | (g) | Cycle | (g) | (g) | (%) | (×1,000) |
| Rencast 6401 | 1,000 | 10,000 | 6.6816 | 6.6352 | 0.7 | 4.6 |
| PU/CNT-OH | 1,000 | 10,000 | 12.217 | 12.193 | 0.196 | 2.4 |
| PU/CNT-COOH | 1,000 | 10,000 | 12.754 | 12.727 | 0.211 | 2.7 |
| PU/f-CNT-COOH* | 1,000 | 10,000 | 12.754 | 12.727 | 0.211 | 2.7 |
| PU/GnP | 1,000 | 10,000 | 6.6251 | 6.6003 | 0.4 | 2.5 |
| PU/GO | 1,000 | 10,000 | 7.5347 | 7.5147 | 0.3 | 2.0 |
| PU/RGO | 1,000 | 10,000 | 5.3814 | 5.3630 | 0.3 | 1.8 |

*chemically functionalized commercial CNTs prepared in the lab

Table 11 below summarizes multiple test results and shows that both GO and RGO composites show the highest anti-corrosion performance.

TABLE 11
Corrosion

| | | Filler | Ecorr | | | |
|---|---|---|---|---|---|---|
| | Type of | contents | (mV vs. | Icorr | PEF | |
| Samples | filler | (wt %) | Ag/AgCl) | (μA/cm²) | (%) | Notes |
| Copper plate | — | — | −365.0 | 11.255 | — | |
| Rencast 6401 | — | — | −179.4 | 1.248 | 92.56 | |
| PU/CNT-OH | CNT-OH | 1 | −171.5 | 0.281 | 98.32 | |
| PU/CNT-COOH | CNT-COOH | 1 | −166.2 | 0.149 | 99.11 | |
| PU/f-CNT-COOH | f-CNT-COOH | 1 | −83.6 | 0.001 | 99.99 | chemically |
| | | | | | | functionalized |
| | | | | | | commercial CNTs |
| | | | | | | prepared in the lab |
| PU/GnP | xGnP M25 | 1 | −91.5 | 0.198 | 98.82 | |
| PU/GO | GO | 1 | −69.2 | 0.004 | 99.96 | |
| PU/RGO | RGO | 1 | −70.1 | 0.004 | 99.96 | |

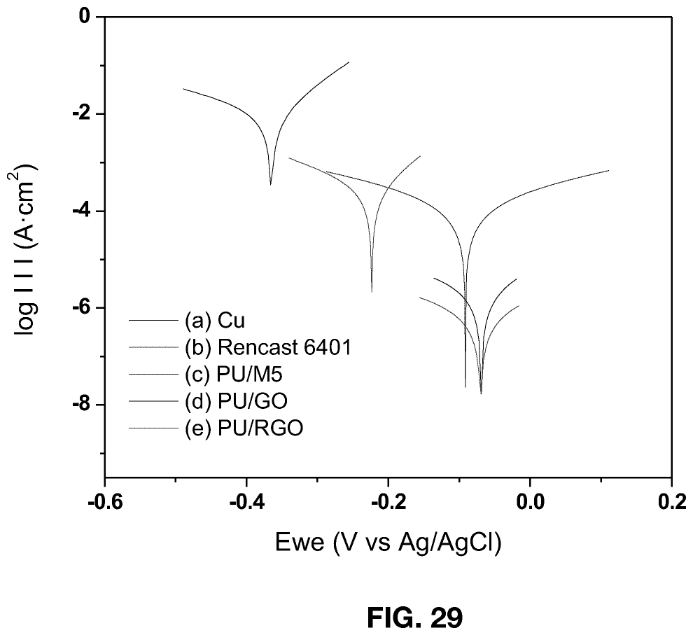

FIG. 29 shows a Tafel plot of copper, indicating that copper can be shifted to lower current and higher potential by adding fillers, particularly GO and RGO.

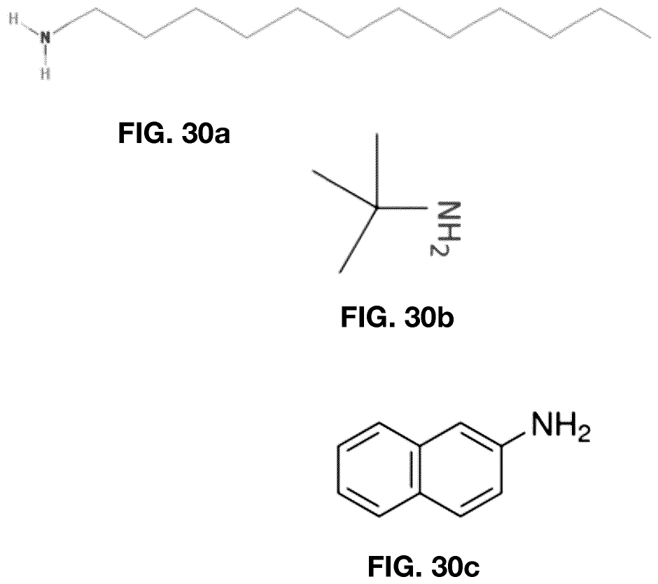

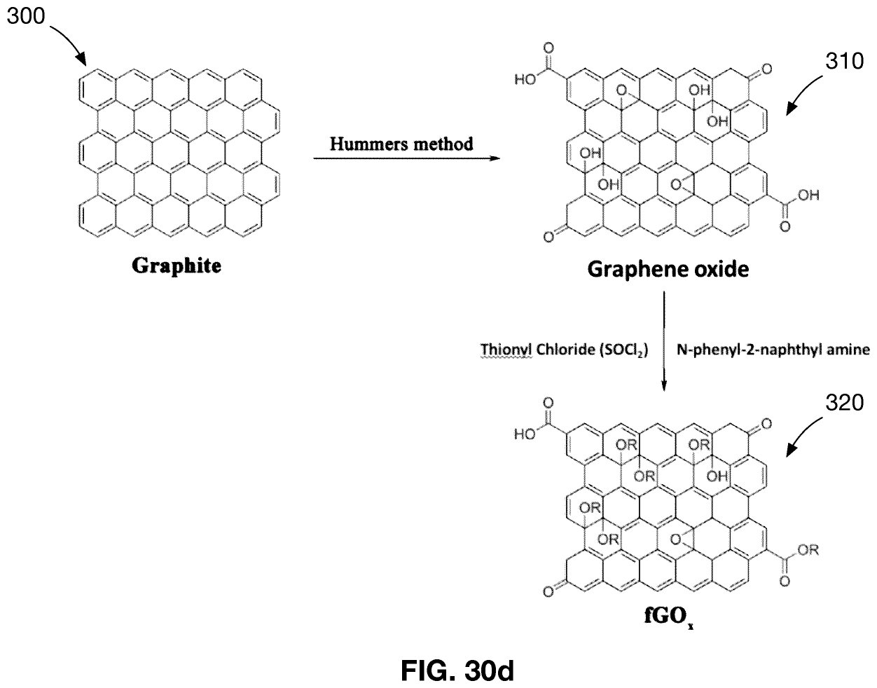

FIG. 30a shows a first surface modifier, dedecylamine. FIG. 30b shows the chemical structure of a second surface modifier, tert-Butyl amine. FIG. 30c shows the chemical structure of a third surface modifier, N-phenyl-2-naphthyl amine.

FIG. 30d shows a method of chemically modifying the surface of GO with a functional group to improve compatibility with the polymer matrix. Graphite 300 is processed using Hummers method to create GO 310. The GO easily reacts with alkyl bromide in a potassium carbonate and water solution to make functionalized GO 320. The functionalized GO can be dodecylamine GO, octylamine GO, or hexylamine GO.

Various approaches have been explored for the functionalization of GO and RGO. One approach is the application of a hydrocarbon group to a PU composite. Hydrocarbon modification of GO provides better compatibility with polyurethane based on its polyol component.

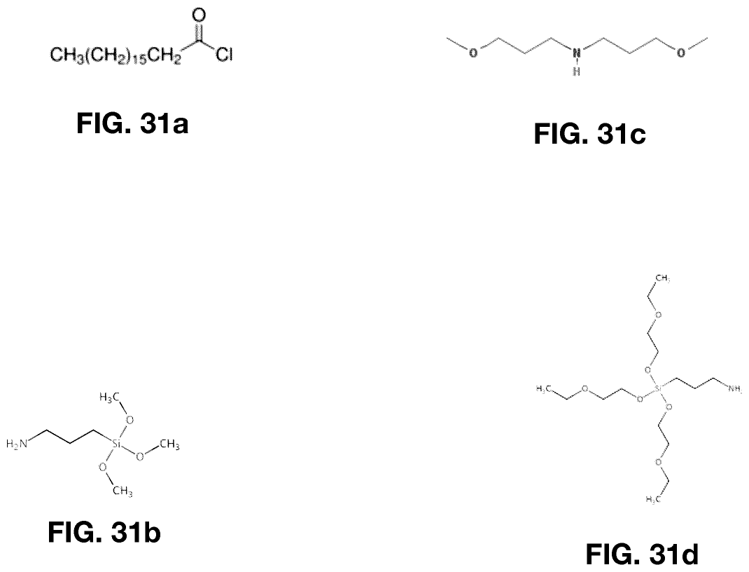

Another suitable approach for the functionalization of GO and RGO is the application of a longer chain hydrocarbon. One such longer chain hydrocarbon is stearoyl chloride (C18) shown in FIG. 31a. Another such longer chain hydrocarbon is oligomeric amine.

The application of multi-branch materials, such as 3-[3-(trimethoxysilyl)propoxy]propan-1-amine shown in FIG. 31b, bis(3-methoxypropyl)amine shown in FIGS. 31c, and 9,9-bis(2-(2-methoxyethoxy)ethoxy)-2,5,8-trioxa-9-siladodecan-12-amine shown in FIG. 31d, can also be used to functionalize GO and RGO.

Still another approach for functionalizing GO and RGO is the surface modification with a polymer compatible with PU. For example, GO and RGO can be functionalized with thermoplastic polyurethane (TPU)/PP, PE, and ethylene vinyl acetate blends (EVA).

The modification process of GO has two steps, such as forming acid chloride and a chemical reaction with an amine group. In one approach used, 50 mg of GO was refluxed with an excessive amount of SOCl₂ (20 mL) including 1 mL of DMF at 70 degrees Celsius under N₂ for 24 hours in order to convert the carboxylic acids on the GO surface to acyl chlorides. After reflux, the residual SOCl₂ was precipitated by centrifuge and the solids were immediately washed with anhydrous THF. The obtained GOCl and 1 gram of reagent was dispersed in 20 mL of THF or DMF. The mixture was stirred vigorously at 50 degrees Celsius for 65 hours. After the reaction, the functionalized GO was separated by centrifuge and the solids were immediately washed with anhydrous THF. The washed functionalized GO was dried in a vacuum at 40 degrees Celsius.

GO that was chemically modified with a naphthyl amine group, in particular N-phenyl-2-naphthyl amine group (“GO2NA”), showed improved compatibility with the polymer matrix.

PU/GO2NA composite showed a higher E-Modulus than PU/GO composite and baseline in another test, as presented below in Table 12.

TABLE 12
Mechanical Properties

| | | | Tensile | Elongation | |
|---|---|---|---|---|---|
| | Contents | E-Modulus | Strength | at break | |
| Samples | (wt %) | (MPa) | (MPa) | (%) | Note |
| PU | — | 15.0 ± 1.7 | 18.4 ± 1.5 | 215 | Rencast 6401 |
| PU/GO | 0.5 | 25.4 ± 1.7 | 21.7 ± 2.3 | 124 | GO from xGnP M25 |
| PU/GO2NA | 0.5 | 33.4 ± 4.6 | 23.4 ± 4.3 | 139 | fGO from GO above |
| Baseline | — | 23.2 ± 1.2 | 31 ± 0.4 | 249 | Reference |

The naphthyl amine group on the GO surface leads to higher interaction with the PU matrix. The tensile strength of PU/GO2NA is lower than Irathane due to an apparent limitation of a lab sample. This is because tensile strength strongly depends on elongation at break. Lab samples might contain more defects than the industrial reference, thus, these defects would lead lower elongation at break than the industrial reference.

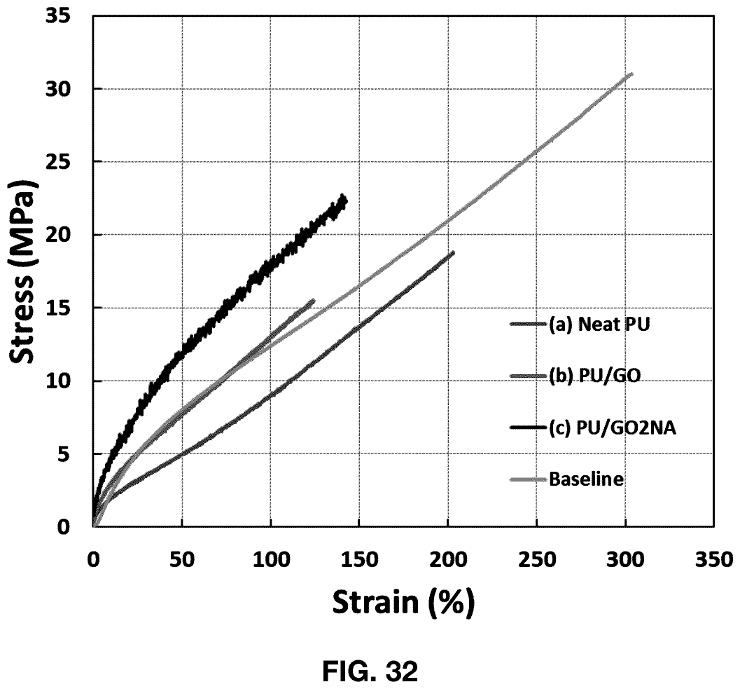

FIG. 32 shows stress graphed versus strain percent for pure PU, PU/GO, PU/GO2NA, and a baseline. As can be seen, PU/GO2NA exhibits more stiff behavior than the reference, neat PU, and PU/GO.

Table 13 below shows that PU/GO2NA showed the highest corrosion resistance among the composites.

TABLE 13
Corrosion

| | | Filler | Ecorr | | |
|---|---|---|---|---|---|
| | Type of | contents | (mV vs. | Icorr | |
| Samples | filler | (wt %) | Ag/AgCl) | (μA/cm²) | PEF (%) |
| Copper plate | — | — | −324.9 | 10.636 | — |
| PU | — | — | −260.8 | 1.469 | 88.28 |
| PU/GO | GO | 0.5 | −99.7 | 0.011 | 99.91 |
| PU/GO2NA | GO2NA | 0.5 | −65.1 | 0.005 | 99.96 |

Naphthyl moiety on GO would be more effective to prevent diffusion of the corrosive agent.

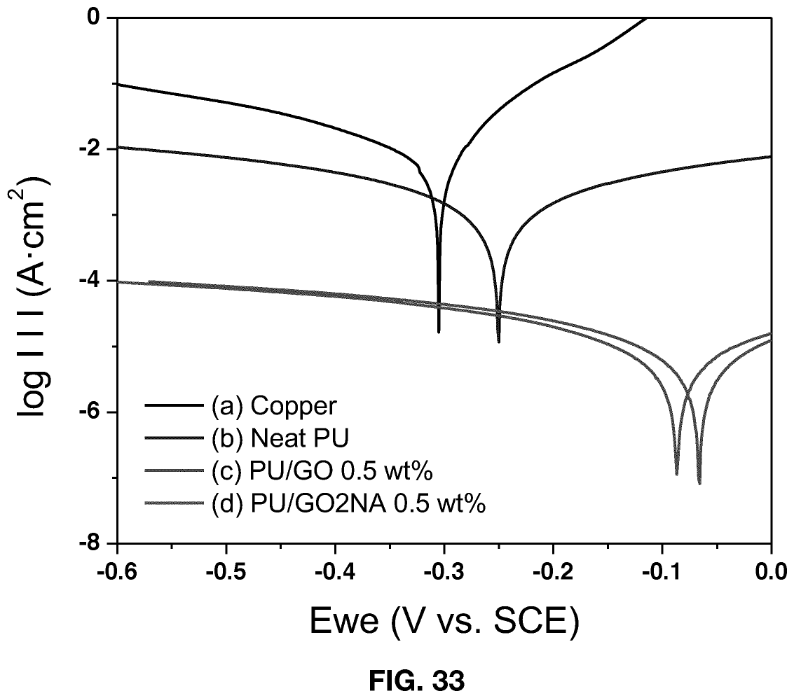

FIG. 33 is a Tafel plot of copper, neat PU, PU/GO 0.5 wt %, and PU/GO2NA 0.5 wt %. As can be seen, the PU/GO2NA composite shows slightly higher corrosion potential and lower corrosion current than PU/GO composite.

The naphthyl moiety of GO2NA provide good mechanical and corrosion properties. Surface-modified graphene oxide (fGO) was successfully synthesized with amine reagent containing a N-phenyl-2-naphthyl group. The PU/GO2NA composite showed the best mechanical properties and corrosion resistance. The naphthyl moiety of the GO surface would lead to strong interaction with the PU matrix and graphene itself. In mechanical properties, the naphthyl moiety would effectively transfer an external force to the graphene sheet due to the interaction between the polymer and graphene. In corrosion resistance, the naphthyl moiety would effectively prevent diffusion of a corrosive agent based on the aromatic structure.

Persons skilled in the art will appreciate that there are yet more alternative implementations and modifications possible, and that the above examples are only illustrations of one or more implementations. The scope, therefore, is only to be limited by the claims appended hereto.

1.-9. (canceled)

10. A fluid transportation conduit system, comprising:
a fluid transportation conduit having an inner surface defining a channel; and
a thermoset polymer having a functionalized carbon-based filler set on the inner surface of the fluid transportation conduit.

11. A fluid transportation conduit system as claimed in claim 10, wherein the carbon-based filler includes carbon nanotubes.

12. A fluid transportation conduit system as claimed in claim 11, wherein the carbon nanotubes are functionalized using at least one of at least one hydroxyl functional group and at least one carboxyl functional group.

13. A fluid transportation conduit system as claimed in claim 10, wherein the carbon-based filler includes at least one of graphene nanoplatelets and graphene oxide.

14. A fluid transportation conduit system as claimed in claim 13, wherein the carbon-based filler is functionalized via at least one of a hydrocarbon group, a longer chain hydrocarbon, a multi-branch amine, and surface modification with a polymer compatible with the thermoset polymer.

15. A fluid transportation conduit system as claimed in claim 10, wherein the coating material is formed by polymerizing an isocyanate-based monomer, an oligomer containing a hydroxyl group, and the carbon-based filler.

16. A fluid transportation conduit system as claimed in claim 13, wherein the carbon-based filler is a graphene oxide that was chemically modified with a naphthyl amine group.

17. A fluid transportation conduit system as claimed in claim 16, wherein the naphthyl amine group is a N-phenyl-2-naphthyl amine group.

18. A fluid transportation conduit system as claimed in claim 10, wherein the fluid transportation conduit is a slurry transportation conduit.

19. A fluid transportation conduit system as claimed in claim 18, wherein the slurry transportation conduit is an oil sand transportation conduit.

20.-27. (canceled)

28. A method of manufacturing a fluid transportation conduit system, comprising:
applying a coating to an inner surface of a fluid transportation conduit, the inner surface defining a channel, the coating being a composite of at least a thermoset polymer and functionalized carbon-based filler.

29. A method as claimed in claim 28, wherein the carbon-based filler includes carbon nanotubes.

30. A method as claimed in claim 29, wherein the carbon nanotubes are functionalized using at least one of at least one hydroxyl functional group and at least one carboxyl functional group.

31. A method as claimed in claim 28, wherein the carbon-based filler includes at least one of graphene nanoplatelets and graphene oxide.

32. A method as claimed in claim 31, wherein the carbon-based filler is functionalized via at least one of a hydrocarbon group, a longer chain hydrocarbon, a multi-branch amine, and surface modification with a polymer compatible with the thermoset polymer.

33. A method as claimed in claim 28, wherein the coating is formed by polymerizing an isocyanate-based monomer, an oligomer containing a hydroxyl group, and the carbon-based filler.

34. A method as claimed in claim 31, wherein the carbon-based filler is a graphene oxide that was chemically modified with a naphthyl amine group.

35. A method as claimed in claim 34, wherein the naphthyl amine group is a N-phenyl-2-naphthyl amine group.

36. A method as claimed in claim 28, wherein the fluid transportation conduit is an oil sand transportation conduit.
